(19) United States
(12) Patent Application Publication
(10) Pub. No.: US 2022/0250959 A1
(43) Pub. Date: Aug. 11, 2022

(54) Water Treatment System and Method of Use Thereof

(71) Applicants: William Tally, Farmington Hills, MI (US); Renew Health Limited, Athlone (IE)

(72) Inventors: William Tally, Milford, MI (US); Jeff Dupuis, Royal Oak, MI (US); Jeffrey Drulia, Royal Oak, MI (US); Michael Kovalcik, Farmington Hills, MI (US); Troy Baertson, Royal Oak, MI (US); Lauren Sabra, Ann Arbor, MI (US); Alex Ruffolo, Ferndale, MI (US); Thomas Reesebeck, Farmington Hills, MI (US); Frank Eberhardt, Detroit, MI (US); Roy Burmeister, Davisburg, MI (US); Dereck Kowalski, Macomb, MI (US); Mitchell O'Brien, Royal Oak, MI (US); Jack Edward Juni, Royal Oak, MI (US); Christian Pavkovich, Livonia, MI (US); Luke Hawrylo, Flint, MI (US)

(73) Assignee: Renew Health Limited, Athlone (IE)

(21) Appl. No.: 17/617,415

(22) PCT Filed: Jun. 9, 2020
(86) PCT No.: PCT/US2020/036855

§ 371 Date: Dec. 8, 2021

Related U.S. Application Data
(60) Provisional application No. 62/979,691, filed on Feb. 21, 2020.
(60) Provisional application No. 62/960,259, filed on Jan. 13, 2020.
(60) Provisional application No. 62/859,186, filed on Jun. 9, 2019.

(51) Int. Cl. C02F 9/00; C02F 1/44; C02F 1/00; C02F 1/28; B01D 61/08

(52) U.S. Cl. CPC C02F 9/005; C02F 1/441; C02F 1/003; C02F 1/283; B01D 61/08; C02F 2201/006; B01D 2311/2649; C02F 2201/005; C02F 2301/046; B01D 2317/04; B01D 2311/04; B01D 2311/25; B01D 2311/06; C02F 2201/007

(57) ABSTRACT

The disclosure relates to a water treatment system which may include at least one reverse osmosis cartridge, at least one filtration cartridge, at least one pump and an enclosure.

### BACKGROUND

There are increasing demands on the public water supply such that public or governmental entities have had difficulty providing adequate water quality for consumption. Further, many individuals may not use a public water supply but instead may use a water source of uncertain quality, such as, for example, well water. In addition, there is an increasing desire to recycle water and to use non-conventional water sources such as, for example, seawater or brackish water. Consequently, there is a need for water treatment systems that may be used to purify water, improve or ensure water quality, or supplement existing water treatment methods.

There are numerous water treatment systems on the market that claim to improve water quality. These systems may use some combination of filtration, adsorption, distillation reverse osmosis or other methods to purify feed water. In general, these systems may be placed in line with a building's water supply to further purify water entering the building. For example, a system may be placed close to the entry point of water into a building, thereby permitting the building's entire water supply to pass through the system for purification. In other examples, water treatment systems may be placed a particular point in a building's water distribution. For example, a water treatment system may be placed adjacent to the supply of drinking water to further purify water from this source. In these and similar circumstances, a water treatment system is preferably relatively compact such that it may be installed and maintained in an existing space, whether that space is inside or outside of a building. Further, water treatment systems should be adaptable to particular situations, including where the source water has unique characteristics, such as increased concentrations of a specific impurity.

There remains a need for a water treatment system that is relatively compact such that may be easily installed or maintained in confined spaces, but which has a high capacity for water treatment, or which is relatively energy efficient. There also is a need for a system that may be customizable for particular water purification situations. There is also a need for a system that is able to recycle water for further purification.

### SUMMARY

Water treatment systems of the disclosure include at least one filtration cartridge, at least one reverse osmosis cartridge, at least one pump and an enclosure. Water treatment systems may have assemblies to facilitate installation or maintenance, including, for example, pump assemblies, tank assembly, an electronics assembly, filtration assemblies, reverse osmosis cartridge assemblies, or post-permeate assemblies.

### BRIEF DESCRIPTION OF THE DRAWINGS

FIG. 1 shows examples of flow paths of water for one example of a water treatment system of the disclosure.

FIG. 2(a) shows a back view of an example of a water treatment system according to the disclosure;

FIG. 2(b) shows a view of the right-hand side of an example of a water treatment system according to the disclosure;

FIG. 2 (c) shows a view of the front of an example of a water treatment system according to the disclosure;

FIG. 2(d) shows a view of the left-hand side of an example of a water treatment system according to the disclosure;

FIG. 2(e) shows an exploded view of an example of a water treatment system enclosure according to the disclosure;

FIG. 3(a) shows a perspective view of an example of a pump assembly of the disclosure;

FIG. 3(b) shows an exploded view of an example of a pump assembly of the disclosure;

FIG. 4 shows a second perspective view of the pump assembly of FIG. 3(b), viewing the pump assembly from another side;

FIG. 5 shows a cross-sectional view of a pump assembly of the disclosure;

FIG. 6 shows an exploded view of an example of a turbine stage according to the disclosure;

FIG. 7(a) shows an exploded view of an example of a recirculation or recycling or disposal manifold assemblies according to the disclosure;

FIG. 7(b) shows a first cross-sectional view of recirculation and disposal manifold assemblies according to the disclosure;

FIG. 7(c) shows a second cross-sectional view of recirculation and disposal manifold assemblies according to the disclosure;

FIG. 8(a) shows a perspective view of an example of a cross support showing the positioning of a manifold assemblies;

FIG. 8(b) shows a perspective view of the example of FIG. 8(a) showing the positioning of a manifold assemblies as seen from another side;

FIGS. 9(a) and (b) show views of an example of a reverse osmosis cartridge assembly in assembled and exploded views respectively;

FIGS. 10(a) and (b) show perspective views of an example of a reverse osmosis cartridge assembly;

FIG. 11 shows an example of a reverse osmosis cartridge assembly as seen in partial cross-section;

FIG. 12 is a fragmented view showing two different cross-sectional views of an example of a reverse osmosis cartridge assembly;

FIG. 13 shows a further cross-section of an example of a reverse osmosis cartridge assembly;

FIGS. 14 (a) and 14(b) show examples of the flow paths of water through a reverse osmosis cartridge assembly for normal operation and flushing operation, respectively;

FIGS. 15 (a) and 15 (b) show perspective views of an example of post-permeate assembly in assembled and exploded views;

FIGS. 16 (a) and (b) show perspective views of the top portion of a post-permeate assembly shown in cross-section and showing an external view;

FIGS. 17 (a), (b) and (c) show one example of a filtration cartridge according to the disclosure as shown in (a) assembled (b) exploded and (c) cross-sectional views;

FIG. 18 (a) and (b) show perspective views of an example of a filtration assembly in exploded and assembled views;

FIG. 19 shows a perspective view of an example the top portion of a filtration assembly;

FIG. 20 shows a perspective view of the top portion of a filtration assembly in partial cross-section;

FIG. 21 shows the top portion of a filtration assembly of a water treatment assembly in cross-section;

FIG. 22 shows an exploded view of an example of a flow meter according to the disclosure;

FIGS. 23 (a) and (b) shows perspective view of an example of an inlet/outlet assembly viewing the top of the assembly;

FIG. 24(a) to (e) show different perspective views and a cross-sectional view of an example of a permeate valve;

FIG. 25 shows an exploded view of an example of a pressure relief valve according to the disclosure;

FIG. 26 shows an example of a tank for a water treatment system according to the disclosure;

FIGS. 27 (a) and (b) show perspective views of an electronic assembly according to the disclosure;

FIGS. 28 (a) to 29 (f) show an example of water treatment system according to the disclosure where the lid is either raised or closed, or where certain components have been removed showing the system interior;

FIG. 29 shows an example of water treatment system according to the disclosure where the with most assemblies removed;

FIGS. 30 (a) to 30 (e) shows an example of a water treatment system according to the disclosure where the enclosure is partially disassembled to show relative placement of system components;

FIGS. 31(a) and (b) show a further embodiment of water treatment system according to the disclosure;

FIGS. 32(a) and (b) show a further embodiment of water treatment system according to the disclosure;

### DESCRIPTION

The systems and methods described herein are not limited in their application to the details of construction and the arrangement of components set forth in the description or illustrated in the drawings. The present disclosure is capable of other disclosure and of being practiced or of being carried out in various ways. Also, the phraseology and terminology used herein is for the purpose of description and should not be regarded as limiting. The use of “including”, “comprising”, “having”, “containing”, “involving” and variations thereof herein, is meant to encompass the items listed thereafter, equivalents thereof, and additional items, as well as alternate examples consisting of the items listed thereafter exclusively.

Other aspects, embodiments, and advantages of these exemplary aspects and embodiments are discussed in detail below. This description is intended to provide an overview or framework for understanding the nature and character of the claimed aspects and examples. The accompanying drawings are included to provide illustration and a further understanding of the various aspects and examples and embodiments and are incorporated in and constitute a part of this specification. The drawings, together with the specification, serve to explain the described and claimed aspects and embodiments.

The disclosure relates to water treatment systems, where a water treatment system reduces impurities in a feed water source that is inputted or flowed into the system. That is, water outputted or flowed from a system after treatment has reduced amounts of one or more impurities compared to feed water inputted or flowed into the system. Impurities removed by treatment, may be, without limitation, particulates, colloids, insoluble material or soluble material, bacteria, viruses, or some combination of these materials. Water treatment systems may remove, for example, and without limitation, organic or inorganic compounds, ions, including individual charged atoms, uncharged molecules or atoms, or some combination of these substances. Systems of the disclosure may reduce, for example only compounds, molecules or atoms having, lead, arsenic, iron, nitrates, nitrites, chromium fluoride, chlorine, chloramine, perfluorooctanoic acid (PFOA), perfluorooctanesulfonic acid (PFOS) or some combination of these substances. According to the disclosure, the feed water may be, without limitation, from a municipal or public water supply, from a well water supply, may be wastewater or may be salinated water, such as seawater or brackish water. Water treatment systems of the disclosure may be customizable or adaptable to the characteristics of a particular source of water. For example, additional filtration components may be added if the feed water has particularly high levels of particulate matter.

Systems of the disclosure may meet industry-established or government-established standards for water treatment systems. For example, systems of the disclosure may meet, without limitation, the NSF-61 standard, the NSF-P473 standard for PFOA, PFOS and other perfluorochemicals (PFCs), the NSF standard for bacteria and viruses, or the LEC 2006 standard for water contaminants.

Systems of the disclosure may produce from about six (6) to about 24 gallons of output water per minute at maximum capacity. In some preferred examples, such as in a residential setting, a system may produce from about six (6) to about 12 gallons per minute (about 8000-17,000 gallons per day. For example, the output of purified water from a system of the disclosure may be greater than nine (9) gallons per minute at 77° F. with 500 TDS water and 40 psi (pounds per square inch) outlet pressure. In other preferred examples, such as in a commercial setting, systems may produce from about to 14 gallons per day to about 24 gallons per day of output water. In particularly preferred examples, systems may produce from about 16 to about 20 gallons per minute (about 23-28 k gallons per day).

In preferred examples, water treatment systems of the disclosure operate from about 32° F. to about 120° F. That is, a system may produce output water or post-permeate water in this temperature range.

In preferred examples, systems of the disclosure may remove up to 5000 ppm of total dissolved solids or up to 15000 ppm of total dissolved solids. For example, a system designed for use in a commercial setting may be used with feed waters having a greater amount of total dissolved solids.

According to the disclosure, water treatment systems may be used in numerous situations that require water purification. In preferred examples, water treatment systems may be used to provide purified water to residential or commercial buildings. In preferred examples, water treatment systems may be placed internally (e.g within a building) or externally (e.g. outside of a building) to residential or commercial buildings. In preferred examples, water treatment systems of the disclosure are placed close to the entrance of a water supply into a building, either externally or internally, adjacent to a building's source. In some examples, two or more water treatment systems may be linked or connected, such as fluidly connected, mechanically connected, electrically connected or some combination of these arrangements. The linked or connected water treatment systems may be placed in parallel, or in series, or some combination of in series or in parallel.

In some examples, compact, enclosed systems of the disclosure allow the purification of water in situations that would be difficult for other water treatment systems. For example, the system may be installed, operated or maintained in relatively small spaces, either indoors or outside. In preferred examples, systems of the disclosure may be shipped as ready-to-use, self-contained units with little or no assembly required, such as occurs with household appliances like washing machines. Systems of the disclosure may also be connected or linked to external components such as a holding or storage tank or may be linked to other types of water treatment systems. In some examples, water treatment systems of the disclosure may be able to be moved easily, such as adjusting the position of the system adjacent to a water source. For example, the system may include wheels or casters placed on the enclosure.

In preferred examples, a water treatment system according to the disclosure includes at least one reverse osmosis cartridge, at least one filtration cartridge, at least one pump and an enclosure. In general, systems of the disclosure include one or more assemblies which may be easily removed from the system or may be easily inserted into the system. Assembly, disassembly, or maintenance of water treatment systems may be facilitated by the use of the disclosed assemblies. The design of the disclosed assemblies may facilitate the incorporation of all components into compact, small-footprint, efficient water treatment systems. The systems of the disclosure may be energy efficient relative to other systems. For example, water treatment systems of the disclosure may produce more output water per energy unit than other systems. In preferred examples, systems of the disclosure may consume about 2.0 watt-hour per gallon per hour to 5.0 watt-hour per gallon per hour, or about 2.5 watt-hour per gallon per hour to 4.0 watt-hour per gallon per hour.

In preferred examples, systems have at least one assembly that includes one reverse osmosis cartridge, at least one assembly that includes two reverse osmosis cartridges, at least one assembly that includes three reverse osmosis cartridges, or at least one assembly includes four reverse osmosis cartridges. In preferred examples, reverse osmosis cartridges may include at least one reverse osmosis unit, or may include at least two reverse osmosis units, or may include at least three reverse osmosis units.

In preferred examples, water treatment systems may include at least one assembly that has at least one filtration cartridge, at least one assembly that has at least two filtration cartridges, at least one assembly that has at least three filtration cartridges, or at least one assembly that has at least four filtration cartridges. In preferred examples, filtration cartridges may include at least one filtration unit, or may include at least two filtration units, or may include at least three filtration units.

In preferred examples, water treatment systems have at least one pump assembly. In some examples, water treatment systems may have two pump assemblies, may have three pump assemblies or may have more than three pump assemblies. According to the disclosure, two or more pump assemblies may be connected in parallel, or in series, or some combination of in series and in parallel.

In preferred examples, components or assemblies of a water treatment system are located within, are enclosed by, or are incorporated into an enclosure. The enclosure provides protection for system components from environmental stress, such as water or particulate matter. For example, enclosures may provide protection for electronics to at least the IP54 standard as defined by the International Electrochemical Commission. The enclosure is formed from materials that are resistant to a range of environmental conditions and to physical stresses. In preferred examples, the enclosure is formed largely from a plastic material. In particularly preferred examples, the enclosure is formed from high density polyethylene. The plastic may have been treated to stabilize the material from ultraviolet radiation. In some examples, other materials may be incorporated into the enclosure for particular situations, including other plastics or metals.

In some examples, one or more components or assemblies may be external to the disclosure but connected to the enclosure. For example, external assemblies or components may be electrically connected to the enclosure, may be fluidly connected to the enclosure, may be mechanically connected to the enclosure or some combination of these arrangements. For example, water may be flowed through one or more filtration cartridges or through one or more pumps before flowing to an enclosure, the enclosure having a water treatment system

In preferred examples, a water treatment system of the disclosure may include at least one tank assembly. The capacity of the tank may be about from six (6) gallons to about 24 gallons, or about six (6) about to about 15 gallons. In a particularly preferred example, the tank contains about eight (8) gallons.

The weight of water treatment systems of the disclosure varies depending on the particular example, as water treatment systems may be customized to a particular situation. In preferred examples, water treatment systems weigh about 200 pounds to about 1000 pounds, or about 300 pounds to 900 pounds, or from 300 pounds to 600 pounds.

Water treatment systems of the disclosure may include at least one electronics assembly. Systems of the disclosure may include at least one flow meter assembly. Systems of the disclosure may include at least one assembly that facilitates the recirculation or recycling of water, such as concentrate. For example, systems may include an assembly that facilitates the recirculation or recycling of concentrate, such that concentrate water is passed through the system, or a portion of the system, such as reverse osmosis cartridges. In these examples, concentrate may be flowed through reverse osmosis cartridges such that the recirculated concentrate is further purified.

Systems of the disclosure may include at least one post-permeate assembly that adds material to purified water, such as adding calcite to permeate. Systems of the disclosure may include an assembly that includes an inlet for flowing water into the system. Systems may include an assembly which includes an outlet, where water is flowed out of a water treatment system. In preferred examples, inlets and outlets may be included in the same assembly.

Water treatment systems may include components for monitoring the status of the system. For example, systems may include at least one sensor, at least one gauge, at least one valve, or other similar devices. Systems may include, without limitation, one or more sensors that detect or measure total dissolved solids (TDS), one or more sensors that measure or detect particulate matter, one or more sensors that detect or measure certain compounds or atoms, such as arsenic, iron, lead, or compounds having these atoms. Systems may include at least one device that measures water pressure, such as a pressure gauge. Systems may include at least one device that measure flow rate at various points in the system. A system may monitor system properties such as TDS in, TDS out, volume of water output (e.g. gallons per minute). A system may monitor inlet water pressure, outlet water pressure, or pump water pressure. A system may monitor inlet flow, outlet flow, or discharge (concentrate) flow. These data may be shown on one or more displays of a system.

Systems of the disclosure may include at least one valve. For example, and without limitation, systems may include at least one pressure relief valve, may include at least one check valve, or may include at least one control valve or may have a combination of these valve types.

In preferred examples, water treatment systems have components that monitor, collect or integrate data from sensors, gauges, valves or other devices that collect data about a water treatment system. In preferred examples, systems of the disclosure include at least one electronics assembly where data about the system is received and processed. The data from the system may be inputted and certain algorithms may be in place to adjust performance of a system based on the inputted data. The water treatment system is therefore adaptable to changes in different feed water sources or changes in water properties during operation. For example, a system may monitor inlet water pressure and adjust relevant valves if the input pressure exceeds a set threshold. A system may use data obtained from monitoring the system to calculate relevant values. For example, predicted remaining filter life, total clean water out, predicted remaining reverse osmosis membrane life, recovery rate of concentrate, or calculated daily usage rate may be displayed. In some examples, the electronics assembly may use established algorithms to recirculate or recycle concentrate for further purification.

The system may display alerts if one or more monitored data or one or more calculated values is close to a pre-set value. These values may be shown on one or more display on an enclosure. The alerts or other information may be transmitted to a remote device, such as a computer.

In some examples, an end user may alter the operation of the system. For example, a user may shut down the system or decrease flow rate when the system is not required. In some examples, a user may use an application on a wireless device to monitor and effect changes in the operation of a system.

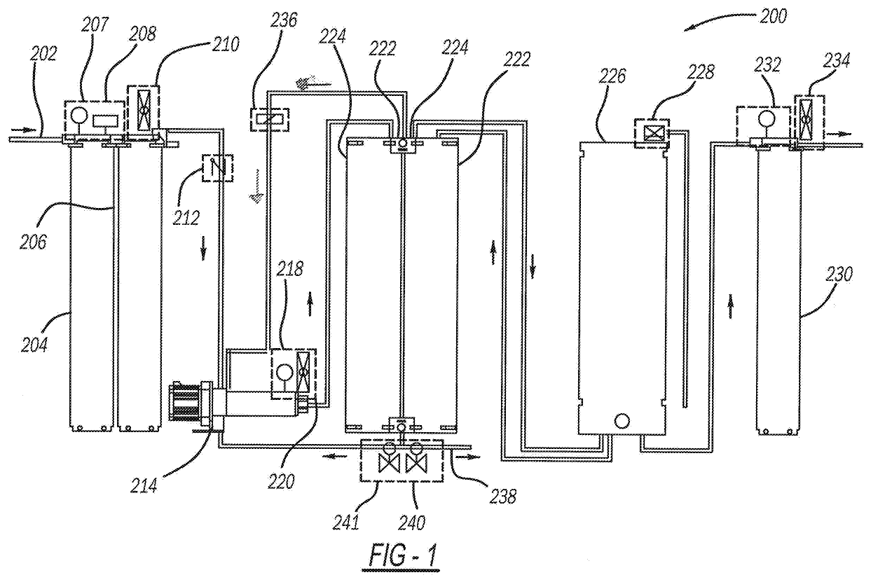

FIG. 1 shows a schematic of one example of a water treatment system according to the disclosure. This example is applicable generally for different versions, such as residential and commercial versions, of water treatment systems. This figure shows schematics of one example for flow paths of feed water, permeate, and concentrate through a water treatment system. In other examples, feed water, permeate and concentrate may have different flow paths depending on the requirements of a particular end user. For example, some users may not require a tank, may require only single filtration cartridge, a single reverse osmosis cartridge, or may not wish to recirculate or recycle concentrate.

In FIG. 1, lines with embedded arrows are used to show flow paths of different water fractions through the system. In this example, feed water is introduced into the system and permeate and concentrate water are produced after flowing through at least one reverse osmosis cartridge. Feed water first may flow through one or more purification steps before flowing through one or more reverse osmosis cartridges. In this example, feed water flows through two filtration cartridges before flowing through reverse osmosis cartridges.

Permeate may be used or stored. In some examples, permeate may be flowed to a filter that adds material to the permeate, such as a calcite filter.

Permeate may also be used to flush the system, thereby removing debris, scale, or material otherwise deposited on surfaces of the system, including the membranes of reverse osmosis cartridges. According to the disclosure, permeate may be stored in one or more tanks, then flowed to one or more reverse osmosis cartridges for flushing to remove undesirable material. In examples, where permeate is used to flush the system, permeate is flowed at higher flow rates through the system than when feed water is flowed through the system for purification.

Concentrate water may be drained from the system for disposal. In preferred examples, a portion of concentrate may also be recirculated or recycled for further purification.

In this example, as shown in FIG. 1, feed water enters the system 200 at inlet 202. Feed water flows to filter cartridges 204 and 206. In this example, each filter cartridge each has both particulate and carbon filter units. In this example, the filtration cartridges are arranged in parallel. In other examples, the cartridges may be in series or both in series and parallel.

Sensors that monitor water quality or water characteristics may be present, such as a sensor 208 that monitors total dissolved solids (TDS). Pressure gauge 207 may be present. A system may include a meter to measure flow rate 210 at this point. In this example, feed water passes from the one or more filtration cartridges to a pump 214. A check valve 212 may be present between the filter cartridges 204,206 and pump 214. In this example, the check valve 212 is a one-way check valve where the check valve prevents the flow of water from the one or more pumps back towards the filter cartridges 204,206. In other examples, water may flow to two or more pumps. In examples where there are two or pumps, the pumps may be placed in parallel or in series or some combination of in parallel and in series.

A pressure sensor and flow meter 218, 220 may be positioned adjacent to and fluidly connected to the pump, thereby measuring the pressure and flow rates in the pump. In this example, the pump 214 flows water to two reverse osmosis cartridges 222,224 which are placed in parallel. In other examples, systems may have one reverse osmosis cartridge, or have more than two reverse osmosis cartridges. In other examples, the reverse osmosis cartridges may be in series or the cartridges may in a combination of in series and in parallel.

In preferred examples, flat membrane sheets used for reverse osmosis are rolled to form a spiral pattern in the cartridge housing. The diameter of the rolled membrane may be from about two (2) inches to about 10 inches. In preferred examples, the rolled membrane is about six (6) inches in diameter. In preferred examples, a reverse osmosis membrane unit may have 10 to 25 leaves or layers. In preferred examples, a reverse osmosis cartridge may have from about 100 to 350 square feet of membrane. In preferred examples, a reverse osmosis unit may have about 280 square feet of membrane.

The flow of feed water through reverse osmosis membranes results in permeate and concentrate water fractions. In this example, permeate flows from the top of the reverse osmosis cartridges to a tank 226 where the water may be stored. In some examples, the tank may serve as a surge tank, such that the tank fills with water when demand is low and empties as demand requires. In preferred examples, the tank may be a hydro-pneumatic tank. The tank may have a bladder. In other examples, the tank may not have a bladder. The tank may be formed from fiber-reinforced plastic.

The tank may include a pressure relief valve 228, to drain water in the event of excess water pressure. In other examples, a pressure relief valve may be placed elsewhere, such as for example, on a post permeate filter assembly. In other examples, a water treatment system may operate without a tank. In preferred examples, the water pressure in a tank may be maintained from about 20 pounds per square inch (psi) to about 100 pounds psi, or from about 40 psi to about 80 psi.

In some examples, a water treatment system may have one or more post-permeate filters through which permeate may flow before use. These one or more filters may adjust the characteristics of permeate, for example, by adding material to the permeate. In the example shown in FIG. 1 the system includes a calcite filter 230. Permeate from, for example, one or more tanks may be flowed through the calcite filter before use. According to this example, there may be a sensor that monitors water quality may be present at this point in the system, such as a sensor that monitors TDS 232. There may include a meter to measure flow rate 234. The system may include a sensor to measure water pressure.

In this example, permeate may also be flowed from one or more tanks to flush at least a part of the system. As shown in FIG. 1, permeate may be flowed from the at least one tank to at least one reverse osmosis cartridge. In this example, permeate flows from the tank through a top element of the reverse osmosis cartridges to the pump. The permeate flow from the tank is regulated by a permeate valve. In this example, solenoid valve 236 is present to regulate the flow of permeate from the at least one tank for a flushing procedure. For flushing, permeate is flowed at high rates through the reverse osmosis cartridges, thereby dislodging, dissolving or otherwise removing deposits on the membranes or elsewhere in the system. In preferred examples, permeate may flow from at least one tank from about one gallon per minute to eight gallons per minute during flushing procedures. In preferred examples, water may be flowed from the pump assembly during flushing from about four (4) gallons per minute to about 20 gallons per minute, or from about five (5) gallons per minute to about 12 gallons per minute.

In preferred examples, flushing with permeate may be done in cycles of pulses of water flow. For example, permeate may be flowed under pressure from at least one tank to one or more reverse osmosis cartridges for a short time period. The pump assembly may operate simultaneously during this time period to facilitate flow of permeate to a pump assembly, then through reverse osmosis cartridges. During the flushing process, permeate flow from at least one tank may be stopped for a short time period and then restarted for another pre-determined time period. The flushing procedure may consist of a predetermined number of such cycles. In other examples, the process be adjusted depending on the characteristics of the flushed water. For example, TDS values may drop after successful a number of flushing cycles and the flushing process may be therefore terminated.

In other examples, the flushing cycle may be determined by the frequency of use of a water treatment system. For example, if the system has been running for more than one hour without interruption flushing may be more frequent, depending on the TDS value. If the system has run less time, the flushing may be less frequent, depending on the TDS level of the input water. If the system has not been running for more than four hours, permeate flush is opened and pump operated is run to circulate permeate water through the system.

According to this example, concentrate may be sent to a drain 238 for disposal. In some examples, a portion of the concentrate may be recirculated or recycled. In examples utilizing recirculation or recycling of concentrate, a fraction of concentrate is flowed to pump assembly 214 where concentrate mixes with feed water. In some examples, water treatment systems may include solenoid valve manifold assemblies for concentrate recirculation and recycling in the system. In other examples, water treatment systems may use at least one step valve. In preferred examples, systems may use two step valves, where one valve regulates the amount of concentrate for mixing with feed water and a second step valve regulates the amount of water for disposal. The solenoid valves or step valves are placed to regulate the volume of concentrate flowed to at least one pump assembly. According to preferred examples, the mixture of feed water and concentrate is flowed from a pump assembly to at least one reverse osmosis cartridge.

In the example of FIG. 1, manifolds with solenoid valve assemblies 240,241 are present. During the recirculation or recycling process, a fraction of concentrate is flowed through solenoid valve manifold assemblies 240 to the pump assembly where the concentrate may be mixed with feed water. The mixture is flowed from at least one pump assembly to reverse osmosis cartridges 222,224 for purification. According to this procedure, the overall efficiency of the system may be improved by reducing the amount of concentrate removed for disposal and thereby reducing the volume or pressure of feed water required to be inputted into the system. A reduction of feed water flow rate or volume due to recirculation or recycling of concentrate may, therefore, reduce feed water costs, reduce required maintenance of the system, increase the lifetime of system components, or some combination of these factors. A fraction of concentrate may flow through manifold 241 then to drain for disposal 238.

When concentrate is recirculated or recycled, concentrate may be mixed with feed water in various ratios such that the tolerances or specifications of the system are not exceeded. For example, concentrate and feed water may be mixed such that the specifications for reverse osmosis membranes regarding TDS are not exceeded. The fraction of concentrate directed for recycling may also be determined by other factors, including, without limitation, the pressure of water flowing into the system, feed water quality, including TDS value, the output flow of water out of the system or some combination of these factors. In preferred examples, one or more of these or other factors are monitored continuously such that the system may adjust the amount of concentrate recycled. In preferred examples, an algorithm is used to determine the optimal operation for recirculating and recycling water. In examples where concentrate is recycled, about 0.1% to about 80% of concentrate water produced by a system may be flowed for recycling, or from about 5% to about 70% concentrate, or from about 10% to about 60% concentrate.

In preferred examples, feed water and concentrate mix in a mixing bowl in at least one pump assembly. Feed water and concentrate may be mixed such that up to about 50% of the water mixed in the mixing bowl is concentrate (i.e. about 50% concentrate, about 50% feed water), or up to about 40% concentrate, up to about 35% concentrate, or up to about 30% concentrate, up to about 25% concentrate, up to about 20% concentrate, or up to about 15% concentrate. In preferred examples, feed water and concentrate are mixed in ratios up to about 65% feed water to about 35% concentrate. For example, concentrate may be flowed into a pump assembly at about 6 to 7 gallons per minute and feed water flowed into a pump assembly at about 10-11 gallons per minute.

In general, systems of the disclosure may use hoses or pipes to flow water or to connect components or assemblies of the system. Materials for hoses or pipes may be selected for one or more characteristics including, and without limitation, cost, corrosion-resistance, wear-resistance, ease of assembly, bacterial growth-resistance, fungal growth-resistance, weight, malleability, flexibility or some combination of these characteristics. In preferred examples, thermoplastic hoses having one or more of these characteristics may be used. In general, systems of the disclosure may use fittings made of one or more materials, such as plastic fittings, copper fittings, or stainless-steel fittings, depending on the requirements of a component. For example, valves may include copper where a reduced incidence of bacterial growth is desired.

Components of the system, such as reverse osmosis cartridge components, that may contact water are formed from materials and which meet established standards for water treatment. In some examples, system components may be formed from acrylonitrile butadiene styrene (ABS) that has been treated to meet standards for water treatment.

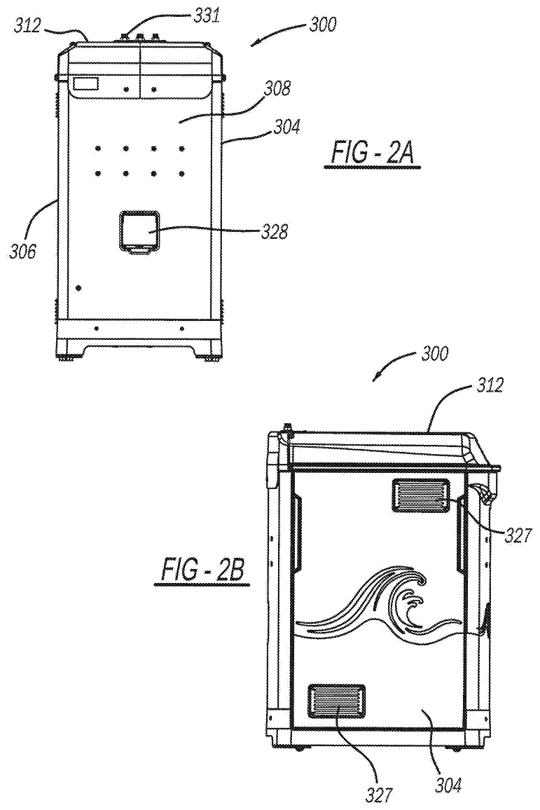

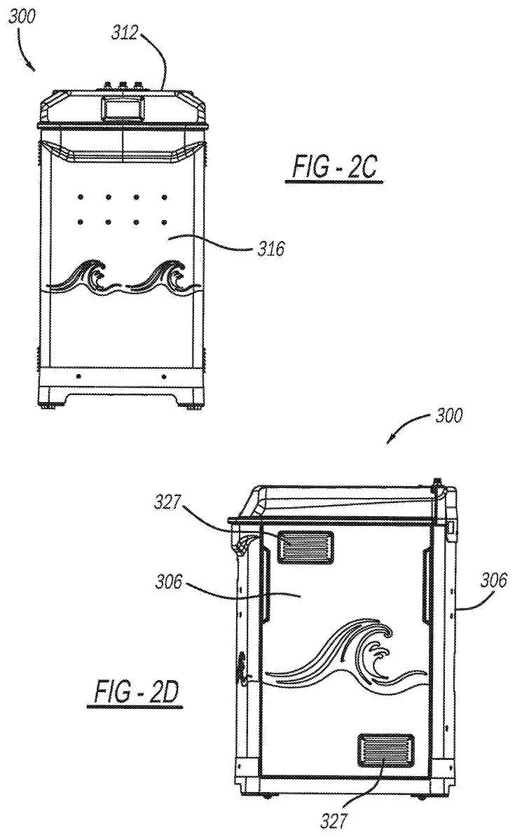

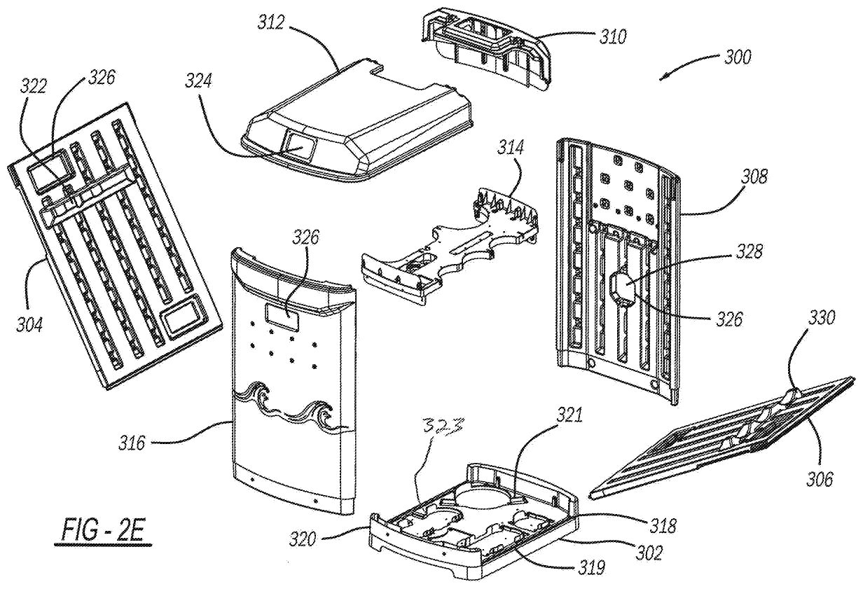

FIG. 2 shows different views of an example of water treatment system according to the disclosure. FIGS. 2(a) to 2(f) show different views of one example of an assembled enclosure. FIG. 2(a) shows a back view of an assembled disclosure, FIG. 2(b) shows the right side of the enclosure, FIG. 2(c) shows the front of an assembled enclosure, and FIG. 2(e) shows the left side of an assembled enclosure. FIG. 2(e) shows one example of an enclosure assembly 300 in an exploded view. In this example, referring to FIG. 2(a) to 2(e), the enclosure is assembled from seven components, including front frame panel 316, back frame panel 308, right side panel 304, left side panel 306, unit base 302, a lid front 312 and lid back 310. FIG. 2(e) also show cross support 314. Cross support 314 is not seen by a user when the enclosure is fully assembled and the lid is closed. In other examples, an enclosure may be assembled from more than seven components, or less than seven components.

As shown in FIG. 2, one or more electronic screens 324 may be placed on the enclosure. The status of the system, such as the value of selected parameters relating to the system performance may appear on the one or more screens. The enclosure may include one or more observation windows 326 through which particular enclosed assemblies or components may be observed. Each component of an enclosure includes an external surface and an internal surface. In this example, internal surfaces of the enclosure may include modifications to facilitate the insertion, mounting or assembly of components, including assemblies of the water treatment system. For example, the internal surfaces may have slots or depressions (318,319,320,321,323) into which assemblies may be placed or mounted. The internal surfaces may have supports or shelves (for example, 322,330) upon which assemblies may be mounted onto or which may support the assemblies. Enclosures may include one or more vents 327. Water connections 331 using an inlet/outlet assembly are shown.

Inlet AC (a powerpack) connection is also shown 328. Water treatment systems of the disclosure may use 110V or may be modified to the requirements of a particular electrical grid. Water treatment systems of the disclosure may be operated using portable electricity sources, such as generators. Water treatment systems of the disclosure may be adapted to particular situation, such as a smaller available space and the dimensions of an enclosure may vary depending on the system components. In one example, a system is contained within an enclosure about 50.5 inches high, 28 inches across, and 36 inches in depth. In other examples, an enclosure about 53 inches high, 28 inches across, and 39 inches in depth.

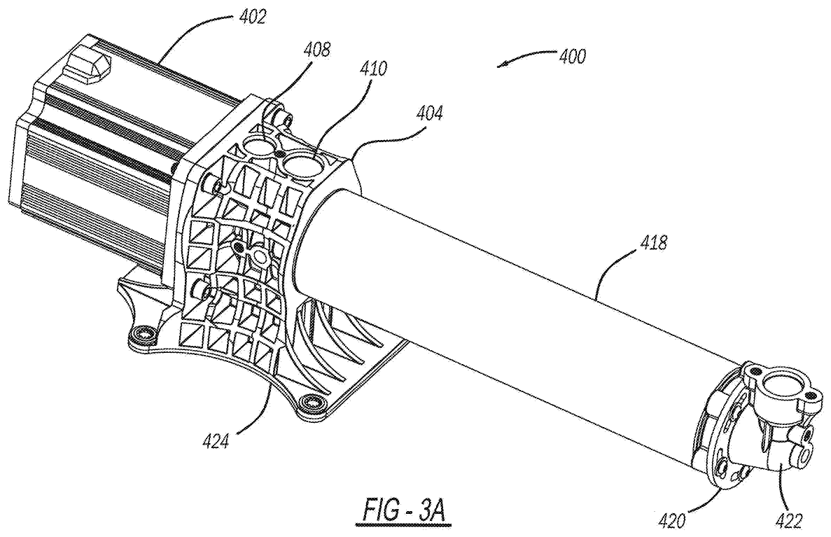

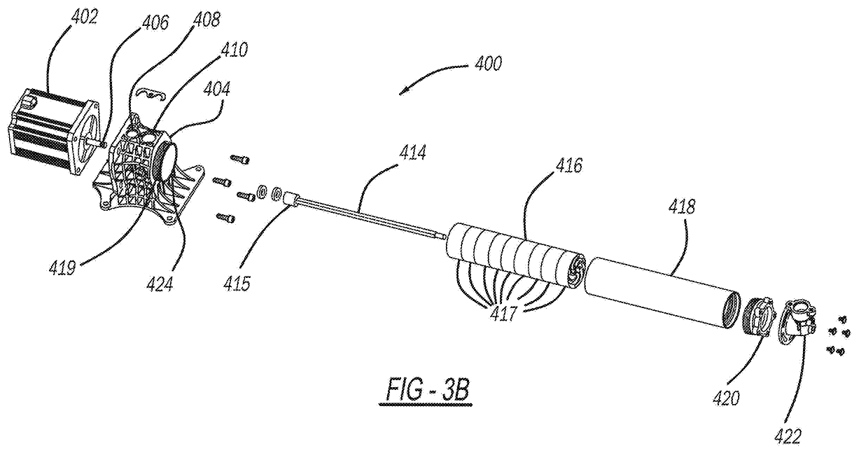

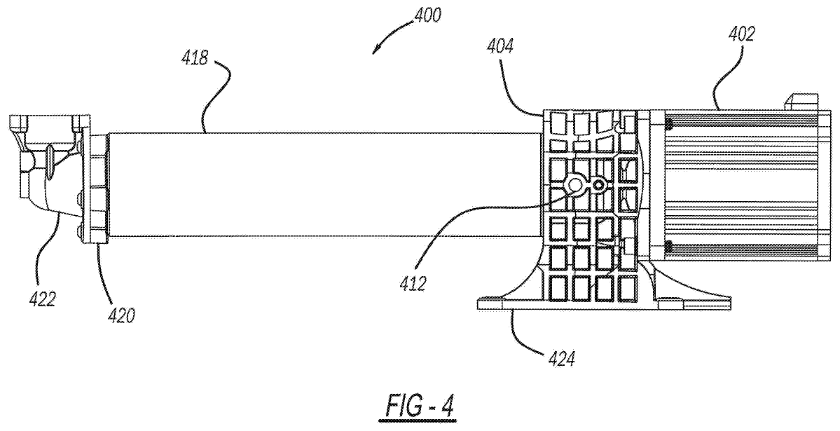

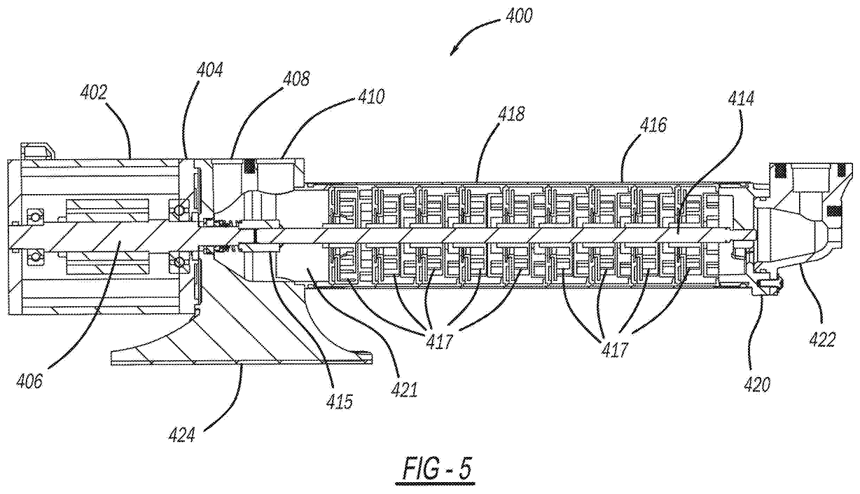

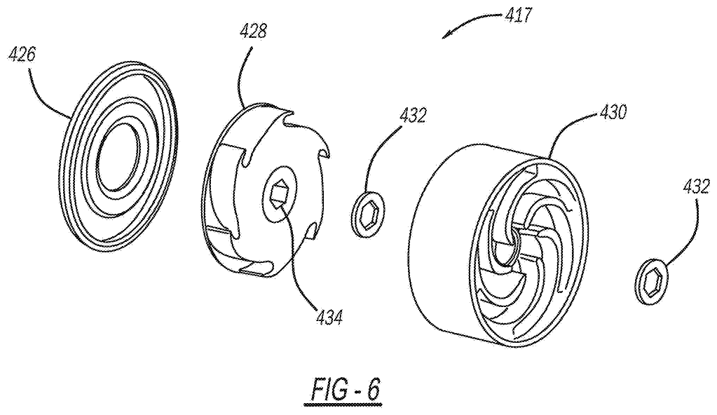

FIGS. 3(a), 3(b) and 4 show one example of a pump assembly 400 in assembled views and an exploded view. FIG. 5 shows a cross-section of one example of a pump assembly, showing aspects of the interior structure. FIG. 6 shows an exploded view of a stage of a turbine of a pump assembly. In this example, pump assembly 400 may receive feed water, permeate, concentrate, or a combination of these fractions. In general, the flow rate of the water is increased to a selected level as consequence of passing through a pump assembly. In some examples, water passes through an outlet to reverse osmosis cartridges. In other examples, the water may pass through an outlet to a different component of the system.

Referring to FIGS. 3-6, pump assembly 400 includes motor 402. In this example, the motor is a DC Motor. The motor may be a variable speed motor. For example, the motor may have an output of three (3) hp. Motor 402 includes shaft 406. The assembly includes a housing 404 which is mounted onto or attached to motor 402. Housing 404 includes three inlet ports 408, 410, 412. Cross-sectional views (FIG. 5) of the housing show mixing bowl 421.

According to this example, port 408 is an inlet for feed water, port 410 is an inlet for permeate, port 412 (shown in FIG. 4) is an inlet for concentrate. In these and other examples, the above-identified ports may be assigned to different water fractions. For example, port 408 may be inlet for permeate in some examples. In other examples, there may be additional ports in the housing. Additional ports may receive feed water, permeate or concentrate. Endcap 420 and outlet 422 are also shown. Pump assembly 400 may be mounted onto the enclosure with mounting plate 424, as shown in FIG. 35.

As shown in FIGS. 3-6, a proximal end of turbine drive shaft 414 engages with motor shaft 406 with an engagement portion 415. Turbine drive shaft 414 passes through opening 419 in housing 404 and engages with turbine 416 along the length of the turbine 416. Turbine 416 is enclosed by turbine housing 418. In this example, turbine 416 includes nine (9) stages 417. The number of stages may be determined by the requirements for the increase in flow rate or by the space available in the enclosure or by a combination of these factors. In other examples, turbine 416 may include from one (1) to as many as 30 stages. A pressure sensor and TDS sensor may be present on housing 404. FIG. 6 shows an exploded view of one stage of a turbine. In this example, a turbine stage 417 is formed from a cassette assembly including from a cassette top 426, an impeller 428, and a cassette vane 430. According to this example, turbine shaft 414 passes through opening 434 of impeller 428. Hex nuts 432 engage with turbine shaft 414.

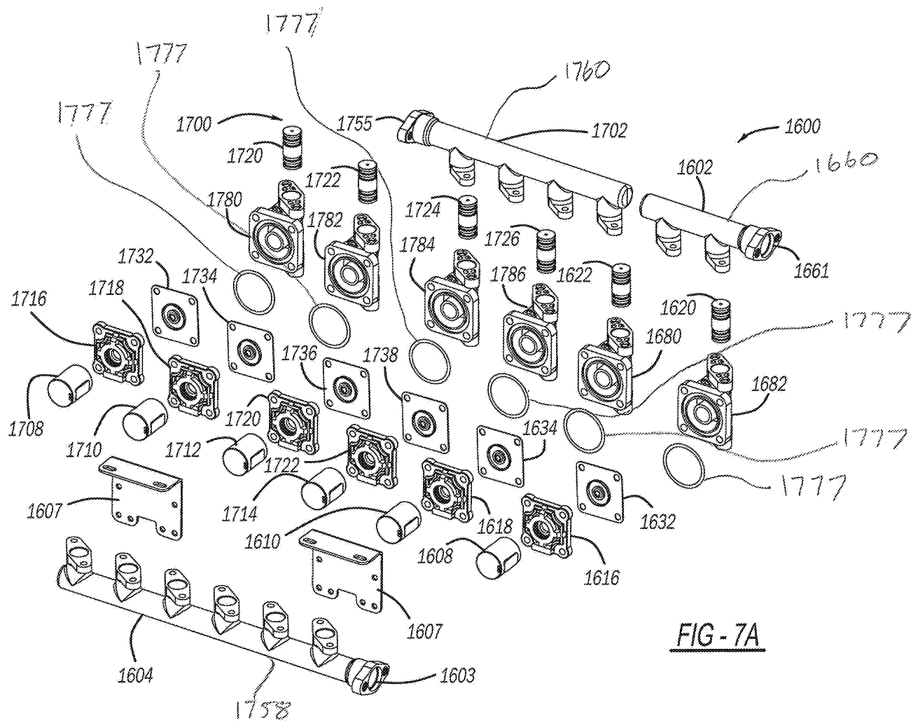

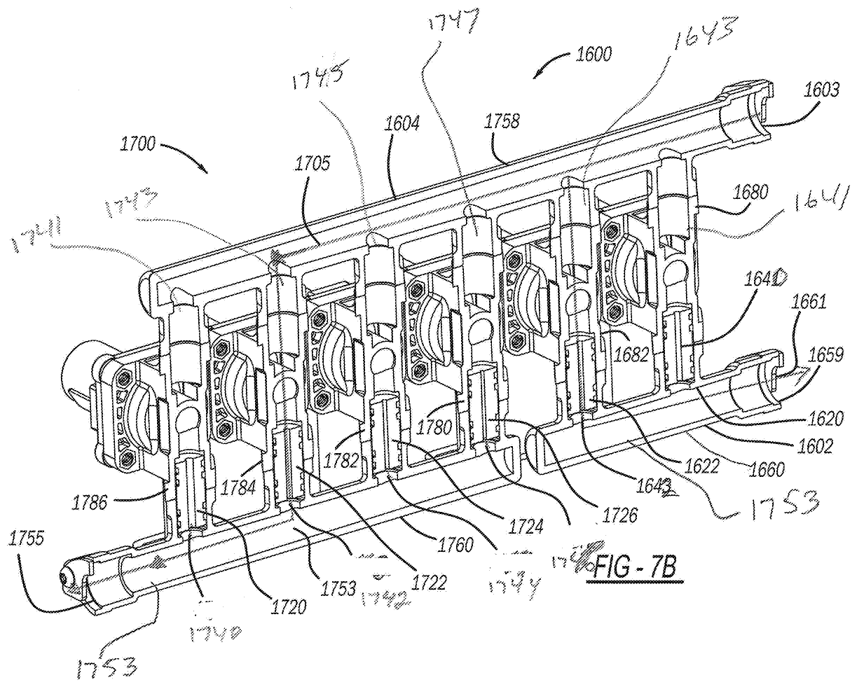

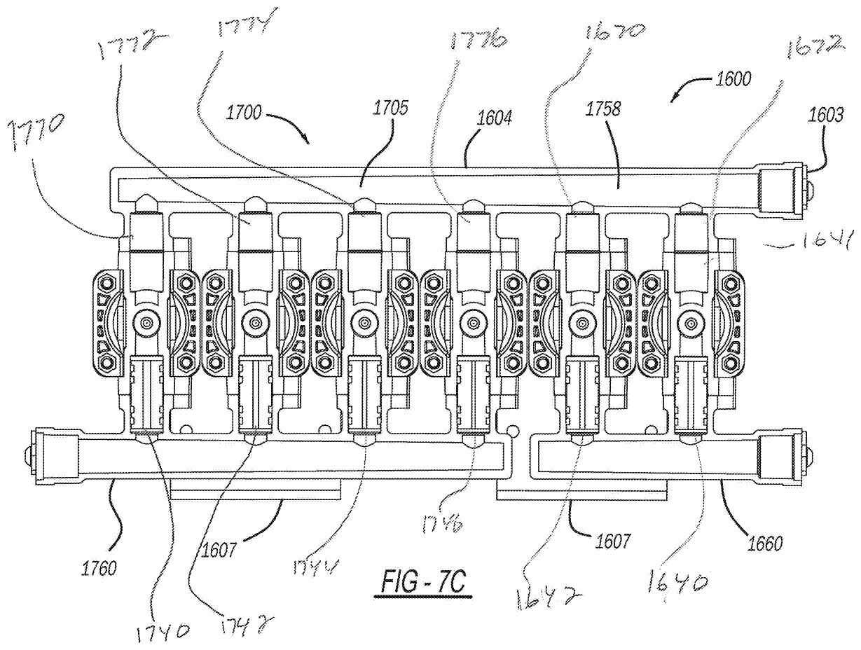

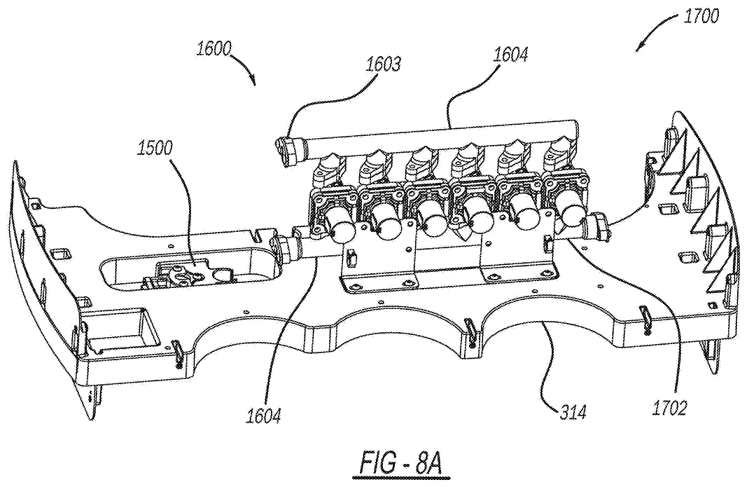

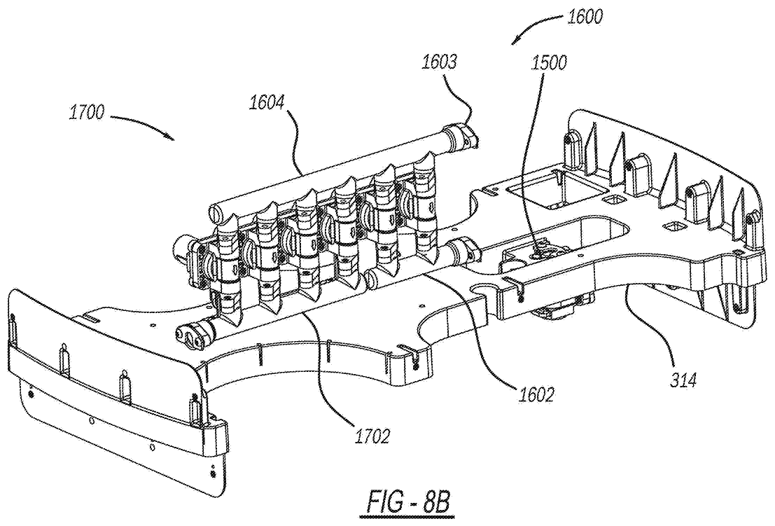

FIGS. 7 and 8 show examples of manifold assemblies used for recirculation or recycling of concentrate. These manifolds may be used to divert a fraction of concentrate for recirculation or recycling or dispose of the remainder of concentrate. FIGS. 7(a), (b) and (c) show an example of manifold assemblies for disposal 1600, or for recirculation or recycling 1700. FIGS. 8(a) and 8(b) show the placement of these assemblies 1600,1700 on a cross support within an enclosure. For the sake of clarity, some elements are not shown in all Figures.

According to the example shown in 7(a), manifold 1700 for recirculation or recycling of concentrate or manifold 1600 for disposal of concentrate are shown. This figure is an exploded view of a recirculation and recycling and disposal manifolds, but shown inverted as to how the assemblies would be placed in a water treatment system. Disposal manifold 1600 shares a common line 1604 with recirculation or recycling manifold 1700 where this line receives concentrate from, for example, at least one reverse osmosis cartridge from inlet 1603. Common manifold section 1758 is shown as well as recirculation manifold section 1760 and disposal manifold section 1660. Inlet 1603 is shown in the common manifold section 1758. Recirculation manifold section 1760 has outlet 1755 and disposal manifold section has outlet 1661. Mounting portions 1607 are also shown, for mounting on cross-support 314.

Manifold 1600 includes solenoids 1608, 1610. Manifold 1700 includes solenoids 1708, 1710, 1712, 1714. Valve seats are shown for disposal manifolds 1600 (1616, 1618) and recirculation manifold 1700 (1716,1718,1720, 1722). Valve diaphragms 1632,1634 and 1732,1734,1736,1738 are also shown. Jet portions 1620,1622,1720,1722,1724,1726 are also shown. Jets 1620,1622,1720,1722,1724,1726 are selected to include channels of different diameters. Valve couplers 1680,1682,1780,1782,1784,1786 are shown as well as O-rings 1777.

FIG. 7(b) and FIG. 7(c) show two different cross-sections through the manifold assembly examples of FIG. 7(a). In FIG. 7(b), one example of the flow of water through the manifolds is shown with arrows. As shown in FIGS. 8 (a) and (b), the manifold assemblies of FIG. 7 are mounted on the crossbar 314 of the enclosure.

In the examples of FIGS. 7b,7c and 7d, the recirculation manifold 1700 includes four solenoids 1708, 1710, 1712, 1714, each with associated jets 1720,1722,1724,1726. As shown in FIG. 7 (c), each jet includes a channel where the diameter of the jet channel 1740,1742,1744,1746 differs between jets. As shown in this Figure, the diameter of the jet channel decreases from left to right. Also, in this example, the disposal manifold assembly 1600 includes two solenoids 1608, 1610, with jets 1620,1622 and jet channels 1640,1642, which also have different diameters.

FIGS. 7(c) and 7(d) also shows additional aspects of one example of manifold assemblies according to the disclosure. Valve couplers 1680,1682,1780,1782,1784,1786 are present. Valve coupler manifolds 1670,1672,1770,1772,1774,1776 link valve couplers to the upper recirculation portion 1758. Valve channels 1641,1643,1741,1743,1745,1747 are also present in valve couplers and manifolds. Water from common channel 1705 flows through one or more valve channels 1641,1643,1741,1743,1745,1747 before passing through one or more jet channels.

According to this example concentrate from at least one reverse osmosis cartridge is flowed through inlet 1603, then through inlet channel 1705, as shown by arrows in FIG. 7(b). In examples where recirculation or recycling of concentrate is desired, at least one solenoid valve is activated in the recirculation manifold assembly 1700, thereby permitting flow of concentrate through the jet channel associated with the selected at least one jet. The activation of particular jets may be determined by an algorithm, for example, considering the properties of feed water, concentrate, the specifications of reverse osmosis membranes, or the specifications of other components of the system.

As shown by arrows in the FIG. 7(b) for this example, concentrate flows through valve channel 1743, then through the selected at least one jet channel 1742, associated with jet 1722. In other examples, concentrate may flow through one or more other jet channels. Concentrate then flows through recirculation channel 1753 to outlet 1755. According to this example, concentrate may then flow to one or more pump assemblies for mixing with feed water, then the mixture of concentrate and feed water may be flowed for recirculation or recycling to at least one reverse osmosis cartridge.

According to this example, concentrate may also flow through at least one jet and associated jet channel for disposal. As shown in FIG. 7(b), concentrate flows through valve jet 1622 with associated channel 1642. Concentrate then flows through disposal channel 1659 through outlet 1661. FIG. 7(d) shows a further cross-section in recirculation and disposal manifolds, 1600,1700.

FIGS. 8(a) and 8(b) also shows the placement of permeate valve 650 on cross support 314. According to the disclosure, permeate valve 650 regulates the flow of permeate from a tank for a flushing procedure.

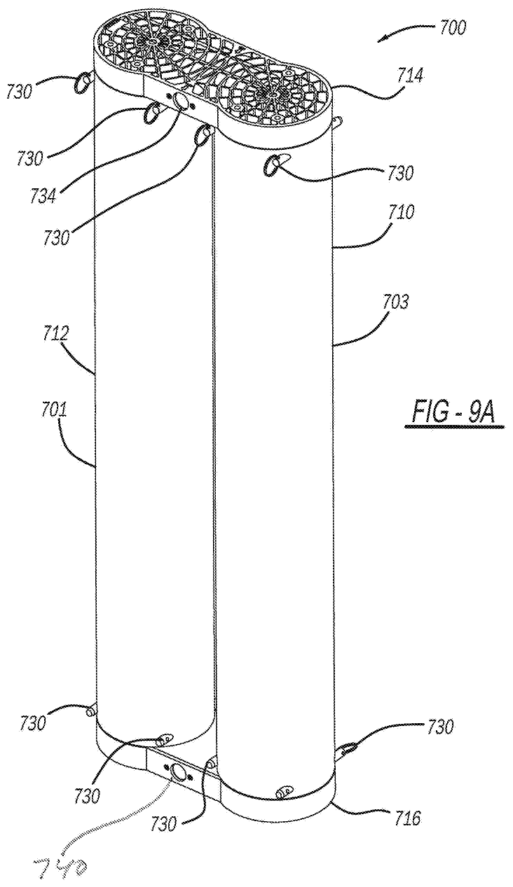

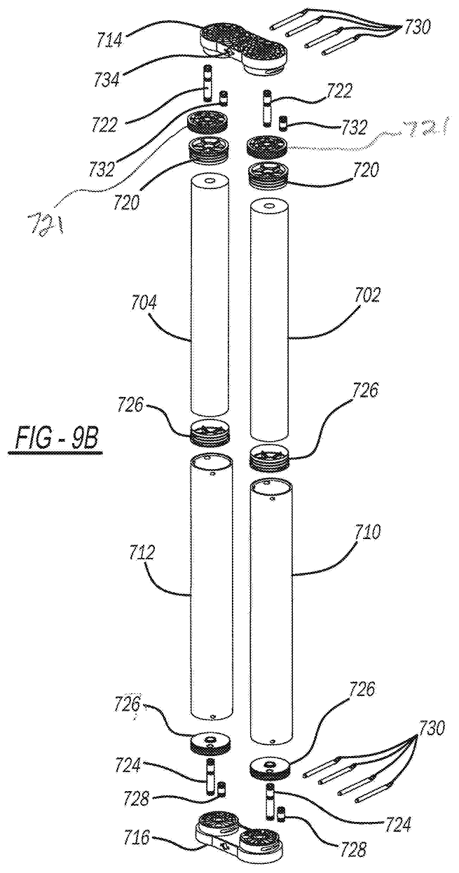

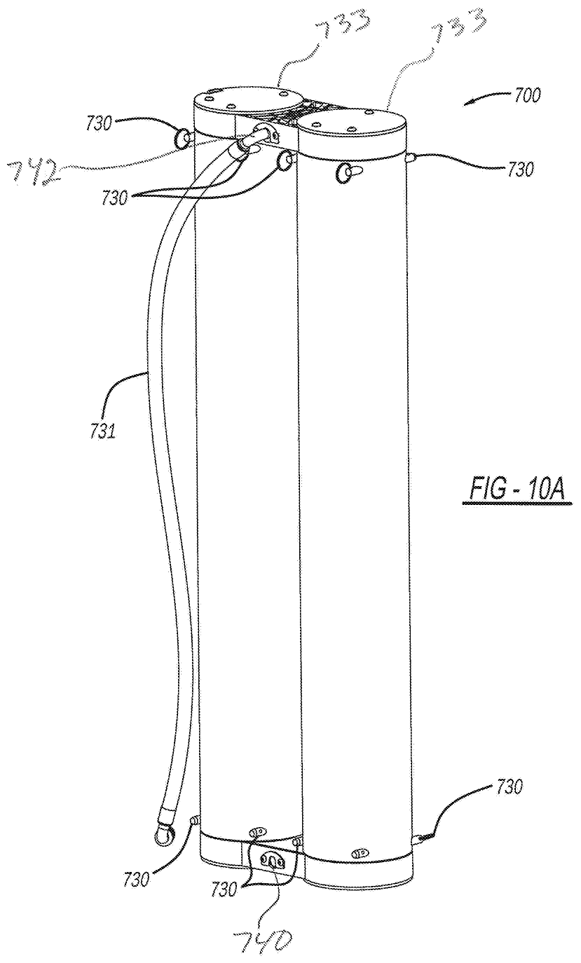

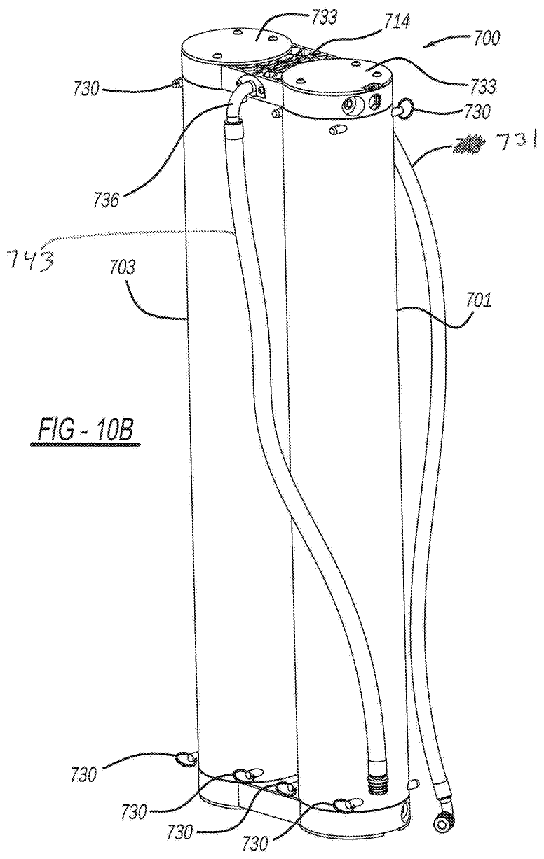

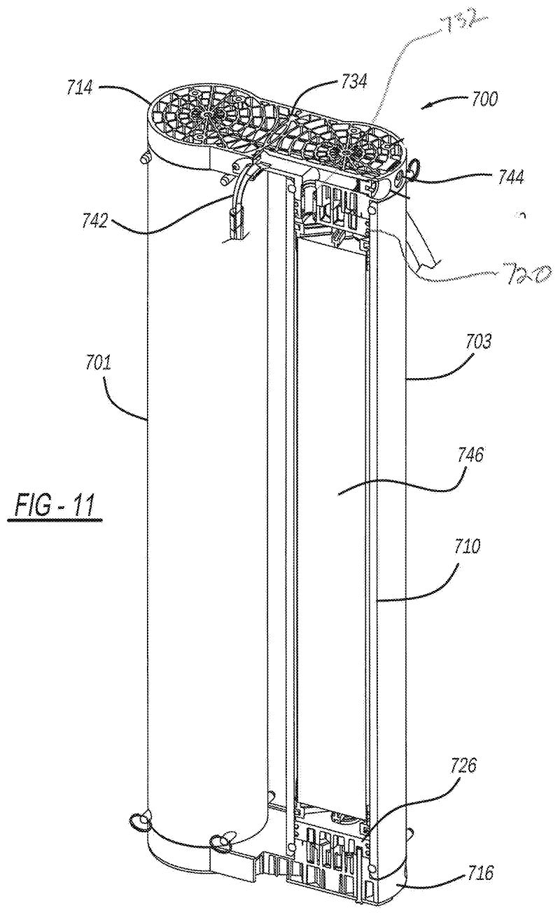

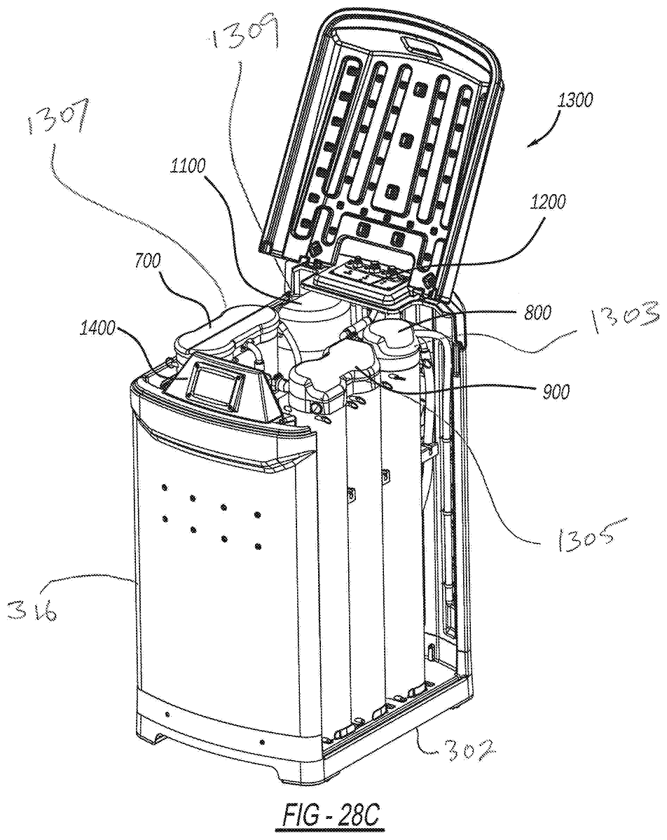

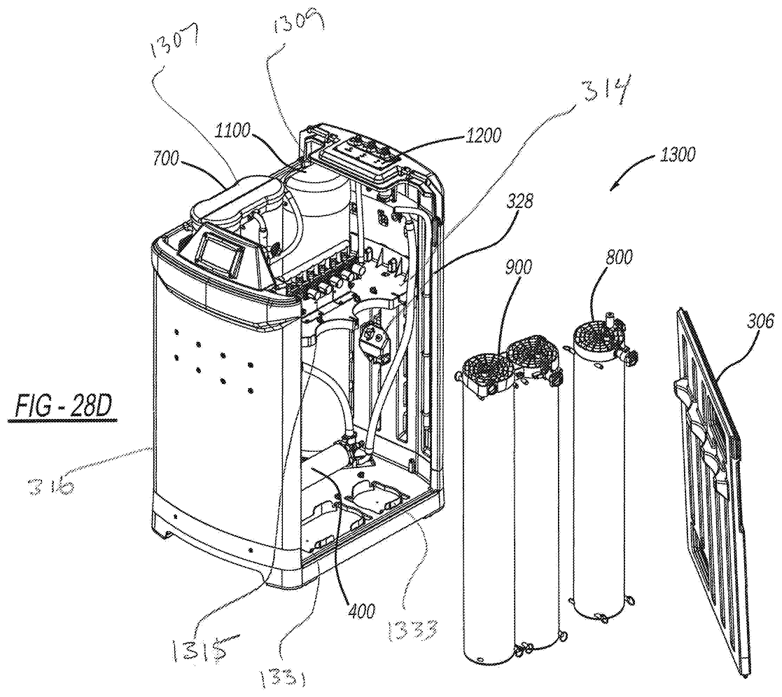

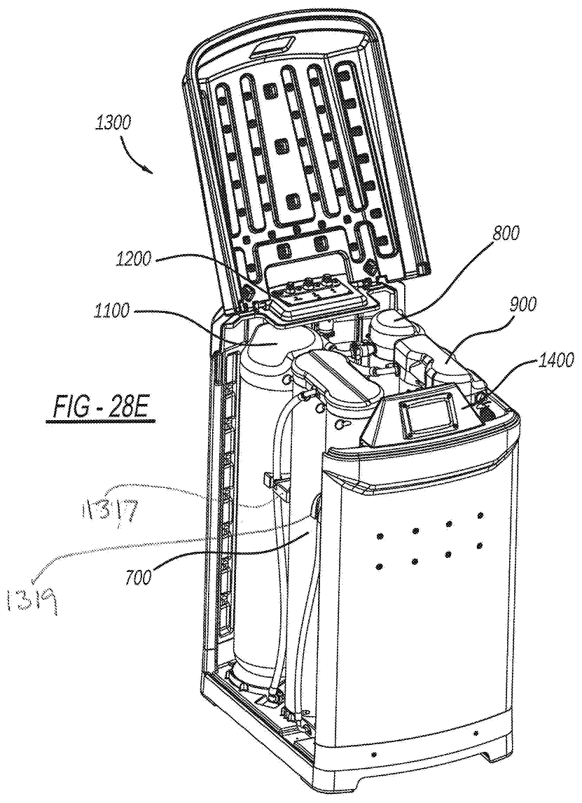

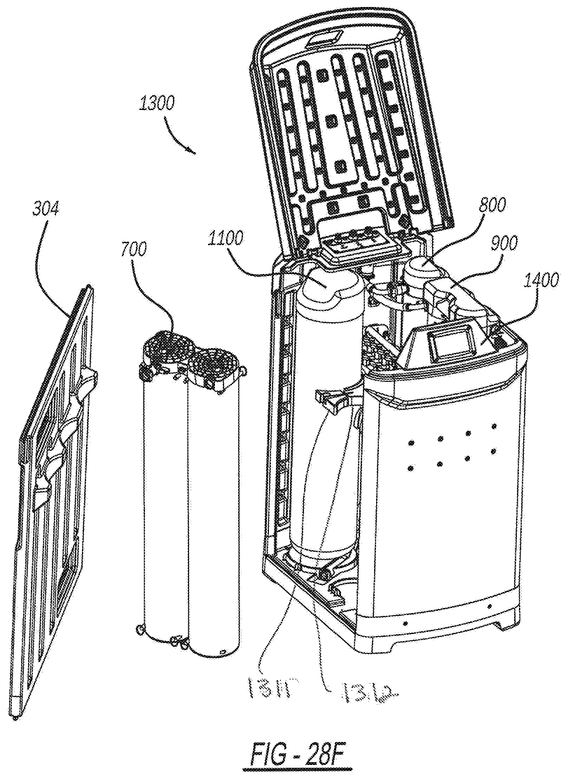

FIGS. 9 and 10 show an example of a reverse osmosis cartridge assembly 700 in assembled and exploded views. FIGS. 11-13 show cross-sectional views of reverse osmosis cartridges. FIGS. 28-32 show examples of reverse osmosis cartridge assembly placed in a water treatment system. In FIGS. 9-13, an assembly 700 has two reverse osmosis cartridges 701, 703. When placed in an enclosure, reverse osmosis cartridges may include caps 733, as shown in FIG. 10.

The reverse assembly includes reverse osmosis elements 702, 704, housings 710, 712, top pass element 714, bottom pass element 716, top endcaps 720, 721, top core nipples 722, bottom core nipples 724, bottom endcap 726, bottom manifold nipples 728, top manifold nipples 732. The assembly includes retaining pins 730. The assembly includes permeate outlet 734, permeate line 736, flush line 744, concentrate outlet 740, and feed water inlet line 742. Hose 731 connected to permeate line 736 is shown. Hose 743 connected to permeate outlet 736 is also shown.

FIGS. 11-13 show cross-sectional views of a reverse osmosis cartridge assembly according to the disclosure to illustrate one example of the operation of this assembly. FIG. 11 shows a section through one cartridge of a reverse osmosis assembly and an external view.

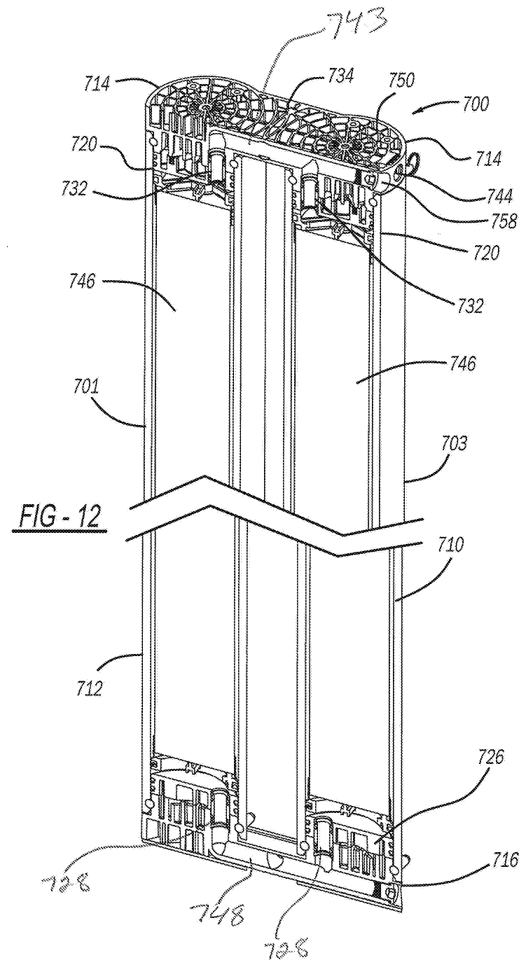

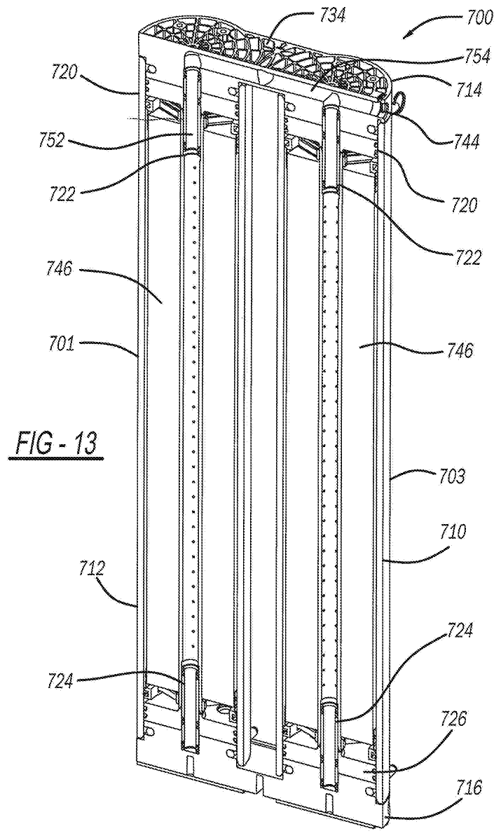

FIG. 12 is a fragmented section, showing features through both cartridges at two different cross-sections. The top fragment shows a section showing permeate channel and the bottom fragment shows concentrate channel 748. FIG. 13 shows a further cross-section of an example of a reverse osmosis cartridge assembly. In FIGS. 11-13, an assembly 700 has two reverse osmosis cartridges 701 and 703. The assembly includes reverse osmosis elements 702, 704, housing 710, 712, top pass element 714, bottom pass element 716, top endcaps 720, bottom endcaps 726, top manifold nipples 732 and bottom manifold nipples 728. The assembly includes pins 730 to hold the assembly together and allow easy disassembly. The assembly includes flush outlet 744, concentrate outlet 740, feed water inlet line 742. These figures also show the positioning of the reverse osmosis membranes 746 in an assembly. This view also shows concentrate channel 748 leading to concentrate outlet 740. Channel 743 for flow of feed water is shown. Plug 758 is shown. FIG. 13 is a further cross-section of an assembly also showing horizontal flush channel 754.

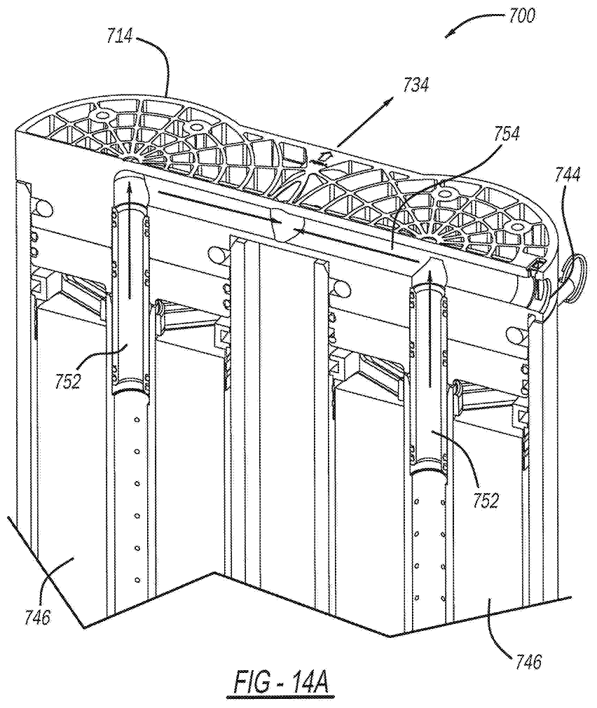

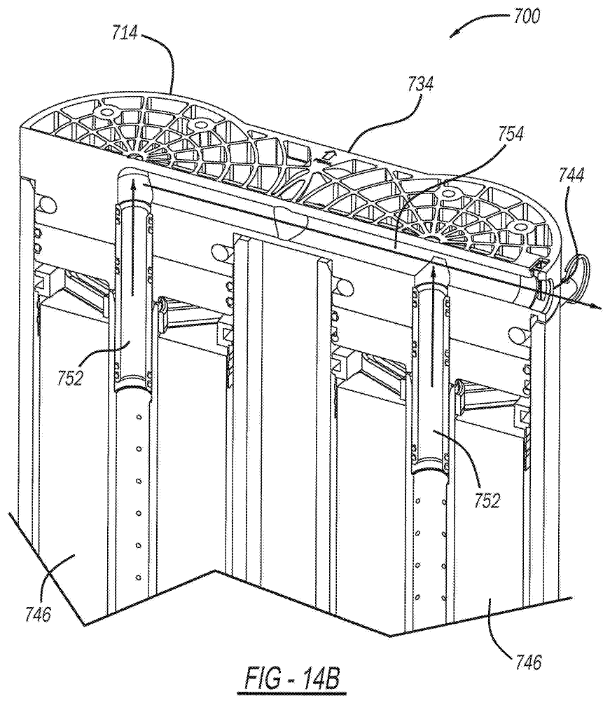

FIGS. 14(a) and 14(b) shows the flow paths of water fractions through a reverse osmosis cartridge assembly during normal operation and during a flushing operation. During normal operation, as shown in FIG. 14a, feed water flows through feed line 742 through feed channel 743 to reverse osmosis cartridges. After passage through reverse osmosis membranes, a permeate and concentrate fraction are formed. Permeate flows vertically through channel 752 to permeate line 736 through core nipples 722, 724, to permeate outlet 734. Permeate may then flow to a tank or may be flowed for use. Concentrate flows through channel 748 through bottom manifold nipples 728 to concentrate outlet 740.

During a flushing procedure as shown in FIG. 14(b), permeate may flow from a tank through permeate water outlet 734, reversing the flow of permeate during normal operation. This permeate flow may be regulated by permeate valve positioned on cross support 314, as shown in FIGS. 8(a) and 8(b). This permeate fraction from the tank mixes with permeate rising through channels 752 and 754. In this example, the mixed permeate fractions flow out flush line 744 to one or more pump assemblies.

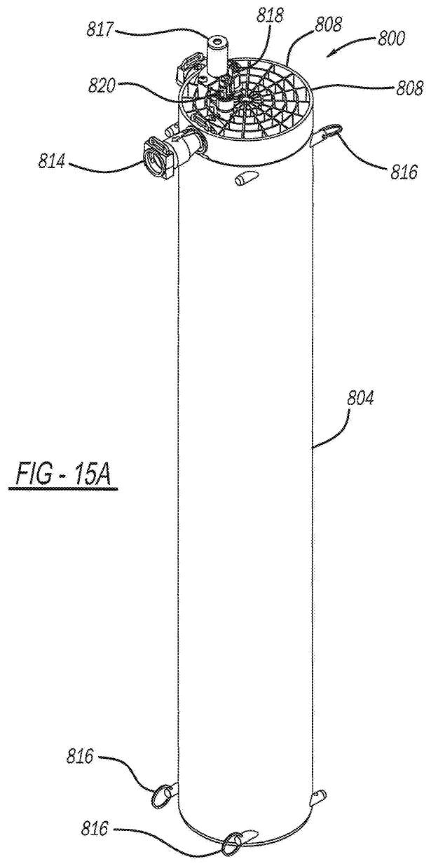

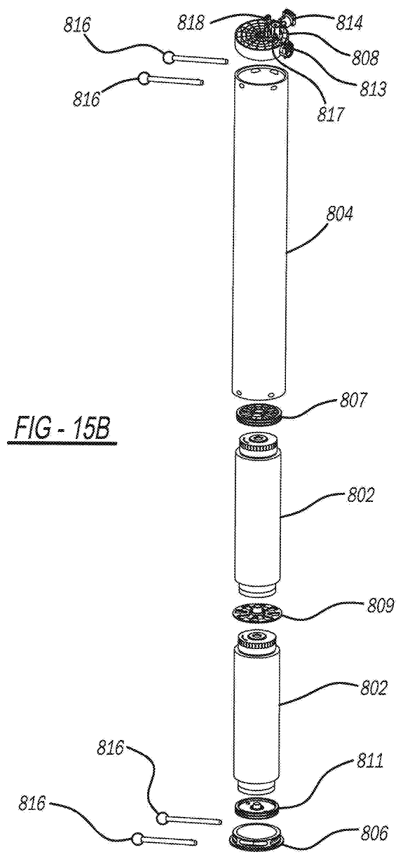

FIGS. 15 (a) and (b) show exploded and assembled views of a post permeate-filter cassette assembly 800 that may be placed in a water treatment system after the generation of permeate. In this example, a calcite filter assembly is placed after a tank where permeate is stored. Permeate stored in the tank may flow to the calcite filter assembly. In other examples, the post-permeate filter assembly may be also placed in water treatment systems. The filter assembly 800 includes two calcite filters 802 contained in housing 804. Bottom end cap 806 and top endcap 808 are present. In preferred examples, the use of at least two calcite filters within one post-permeate cartridge facilitates assembly, disassembly or of system components. For example, the filters may be more easily inserted or replaced in enclosed spaces. Top endcap includes an outlet 810 for flowing permeate after passing through the calcite filter. Flow meter 812 may also be included at this point. Inlet 814 is present where, in this example, permeate is flowed from a tank through the inlet. Retaining pins 816 are present.

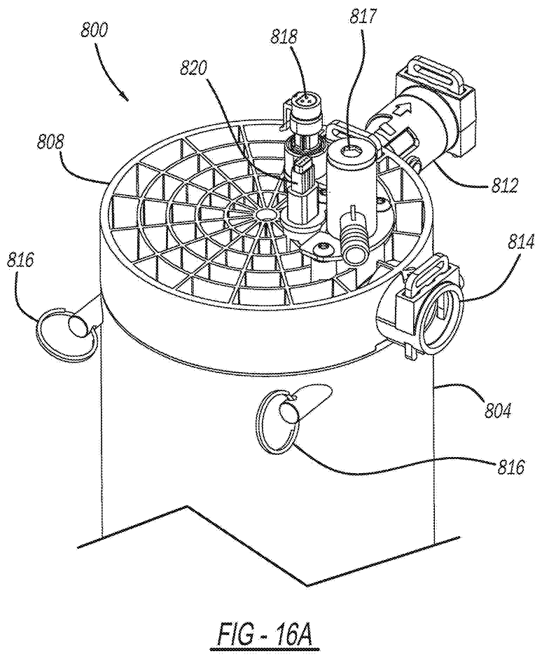

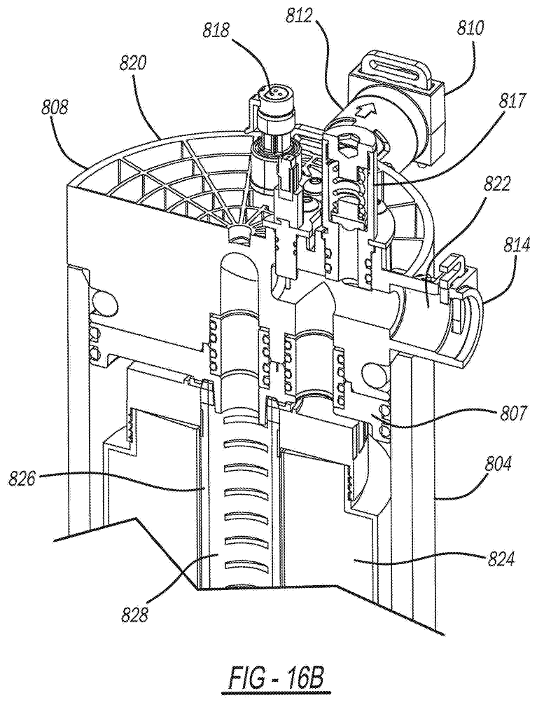

FIGS. 16(a) and (b) show enlarged views of a top portion of post-permeate filter assembly. Assembly 800 has calcite filters 802 enclosed in housing 804. Top endcap is present 808 with pressure gauge 818 and TDS sensor 820 also shown. Spacer 807 is present. Inlet 814 is shown and inlet channel 822 is present is shown in cross-sectional views. Outlet tube 826 is shown with outlet cassette channel 828 shown in cross-section. Top endcap has channel 830. Flowmeter 812 and outlet 810 is present. According to this example, permeate may flow from a tank, through inlet 814, through cassette inlet channel to calcite resin 824. Post-permeate water flows through outlet channel 828 to endcap channel 830 to flow meter 812 and outlet 810.

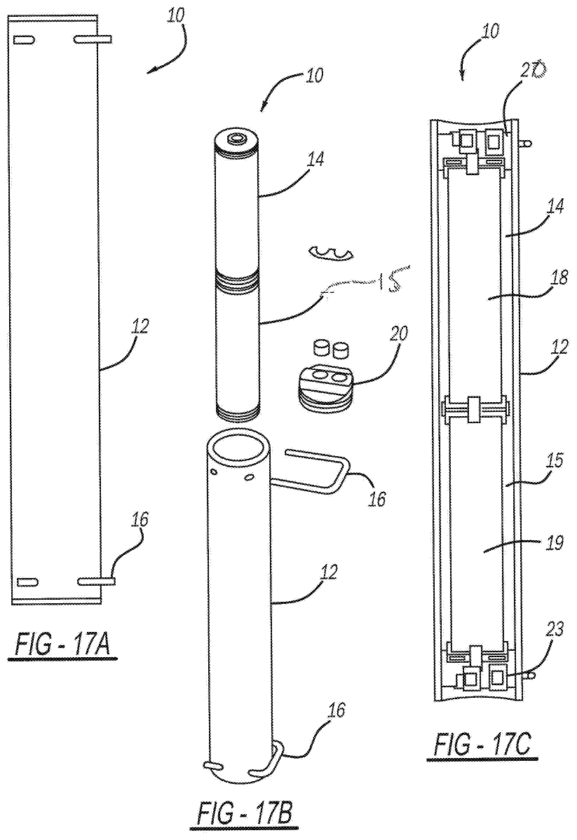

FIG. 17 (a) to (c) shows one example of a filtration cartridge according to the disclosure in assembled and exploded views. Cartridge 10 includes housing 12. Two filtration units 14,15 are shown placed in the housing 12. Top cap and bottom cap 20,23 are shown as well as retaining pins 16. In cross-section, filtration resin is shown 18,19, In this example, the filtration cartridge has two types of filtration units and two types of filtration resin, such as, for example, particulate filters and carbon filters. Channel 22 is present.

Filtration media within each filter cartridge may be selected according to the circumstances of a particular water source. For example, a first filter media may be a sediment or particulate filter and a second filter may be a granulated activated carbon (GAC) filter. In other examples a first filter may be a combination of sediment and carbon materials and a second filter may be a carbon filter. This arrangement be suitable, for example, where the chlorine content of the input water is significant. In some examples, the first or second filter media may include catalytic carbon. Catalytic carbon may be effective in removing chloramine.

In preferred examples, the sediment and carbon media fill a filtration unit housing having a diameter from about three (3) inches to about seven (7) inches. In some preferred examples, filter media fill a diameter of about four (4) inches. In other preferred examples, filter media fill a diameter of about 5.25 inches.

In preferred examples, the housing of a filtration cartridge may be from about 35 to about 50 inches high. In preferred examples a housing is about 40 inches high. The overall height of a filtration cartridge in this case may be about 44 inches.

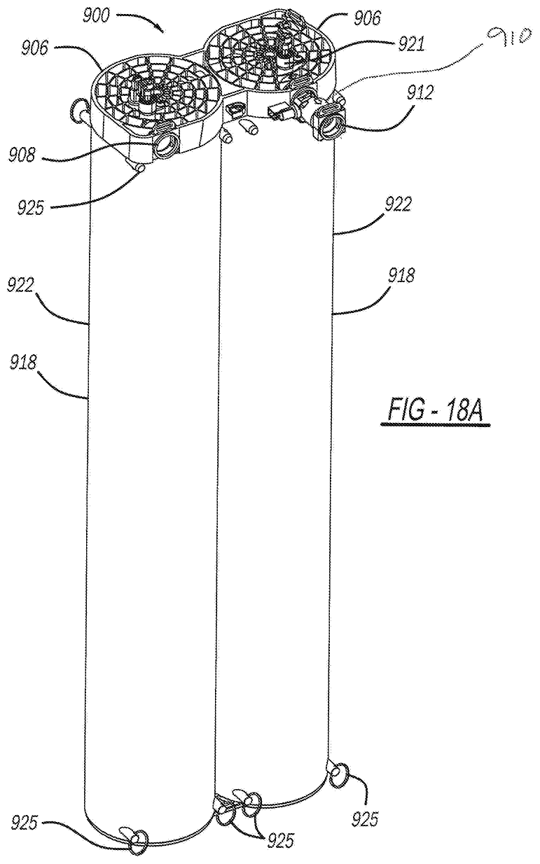

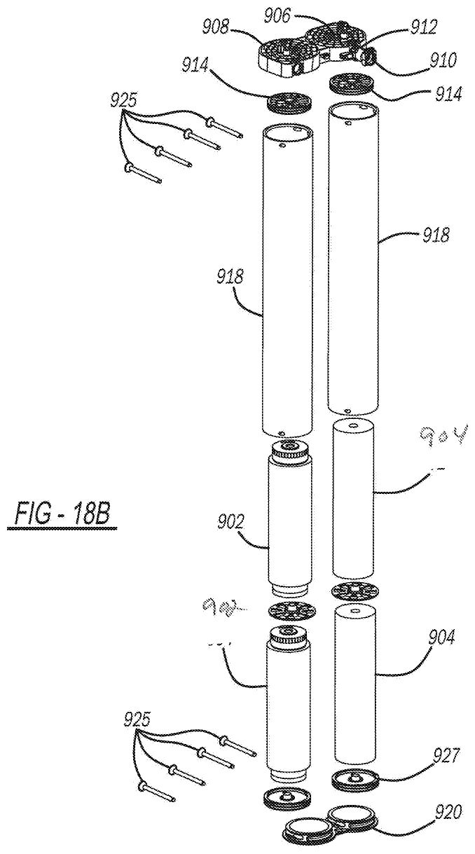

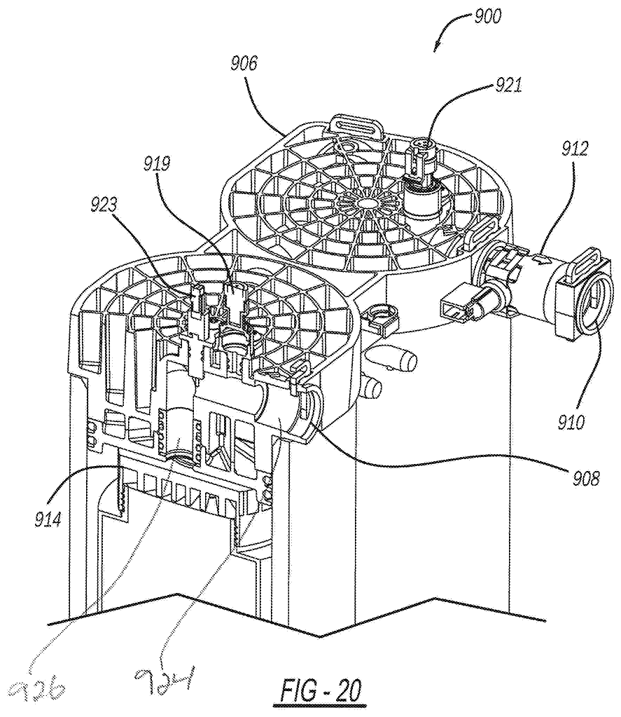

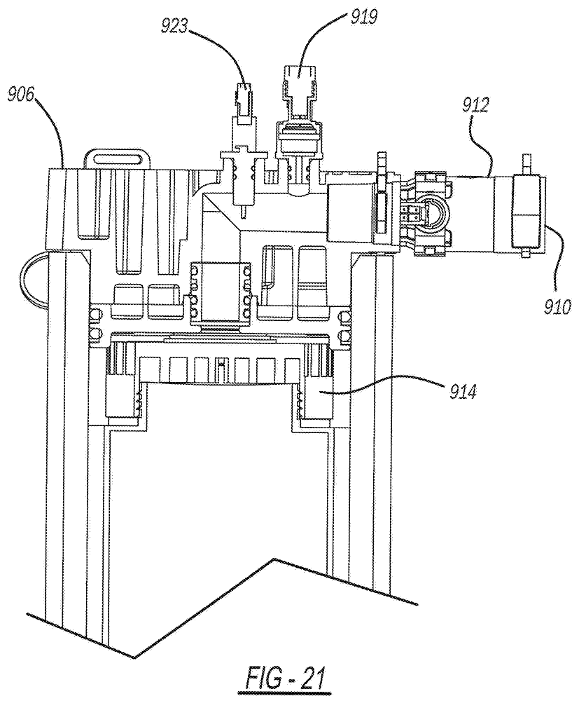

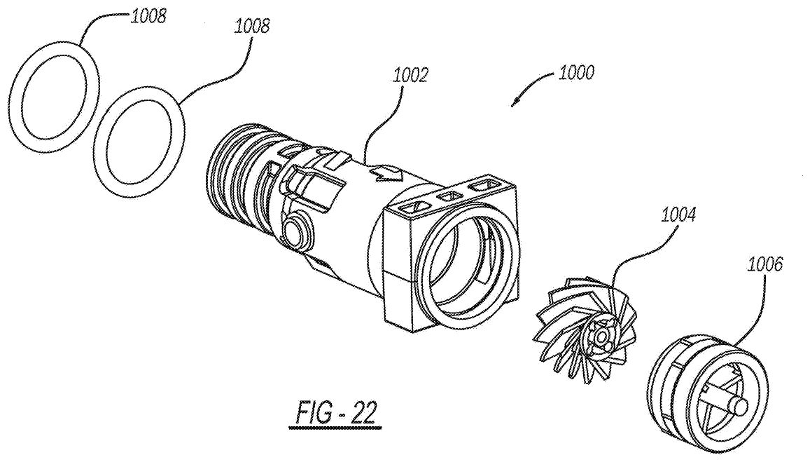

FIGS. 18(a) and 18(b) show another example of a filtration assembly according to the disclosure, showing both assembled and exploded views. FIGS. 20 to 22 show enlarged views of a top element of a filtration assembly according to the disclosure, with FIGS. 21 and 22 in cross-section in part or in full respectively. Assembly 900 includes two cartridges 922 with two housings 918 where each housing 918 includes two particulate filter unit 902 or two carbon filter unit 904. The presence of two filter units in one filtration cartridge permits easier installation, maintenance or replacement of the filtration units.

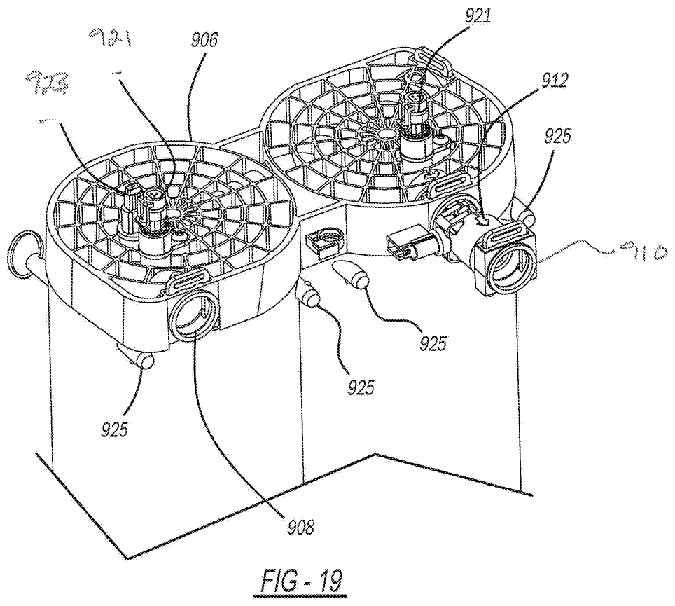

In this example in FIGS. 18(a) and 18(b), the cartridges are in series and feed water flows through a particulate filter first then the carbon filter units. Bottom endcaps 920 and top endcap 906 are present. Inlet 908 and outlet 910 are placed are on top endcap with flow meter 910. Spacers 914 are present. FIGS. 19 to 21 show enlarged views of an assembly in perspective and in cross-section. In these views, assembly 900 includes pressure sensors 919, connected with element channel 926. Retaining pins 925 are present. In other examples, each cartridge may have different types of filtration units and the cartridges are in parallel.

FIG. 22 shows an exploded view of one example of a flow meter according to the disclosure. Flowmeter 1000 includes flow meter body 1002, turbine 1004, spindle 1006 and seal 1008. Water flows in the direction of the arrow shown on the flow meter body 1002. Flowmeters may be placed at selected points in the system, including, for example, the pump assembly.

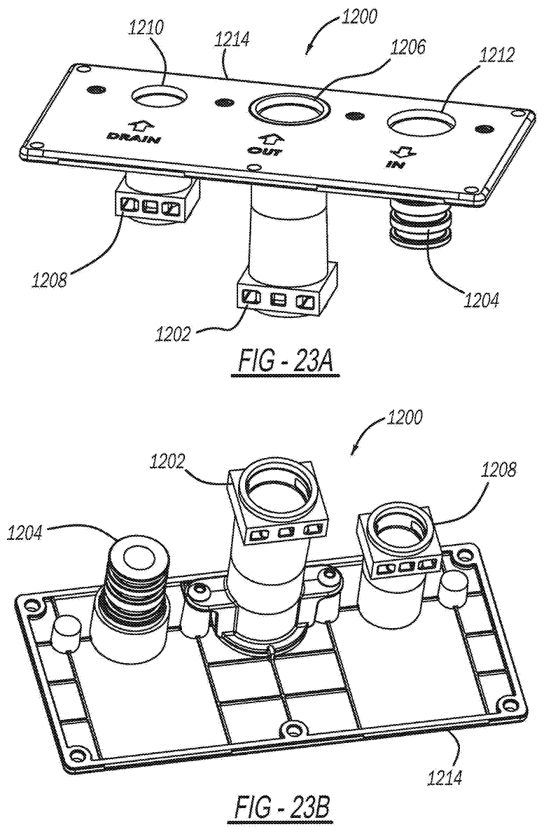

FIGS. 23(a) and (b) show an example of an inlet/outlet assembly, as seen in a top view and a bottom view, respectively. Assembly 1200 includes outlet 1202 with opening 1206. Plate 1214 is present. In preferred examples, permeate water flows from the system out of outlet 1202 for use, having flowed through the system including a post-permeate filter. Feed water may enter the system at opening 1212 through inlet 1204. According to this example, concentrate may be flowed out the system through drain 1208 with opening 1210.

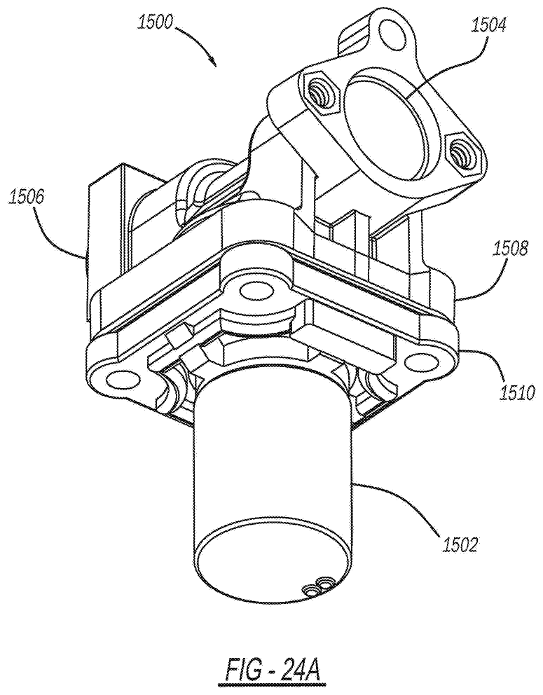

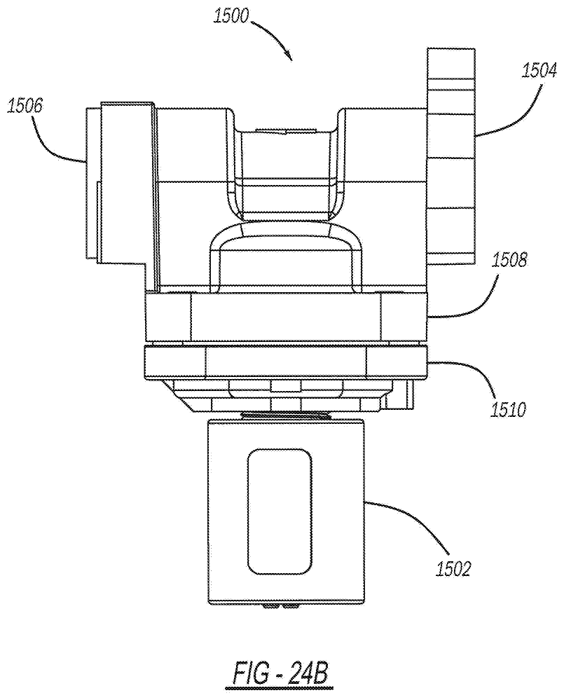

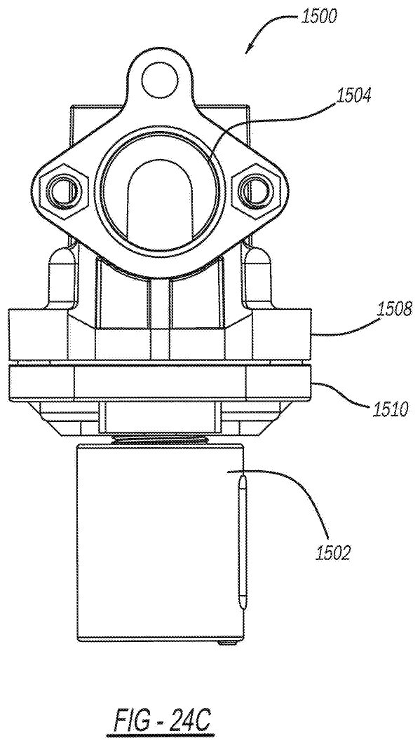

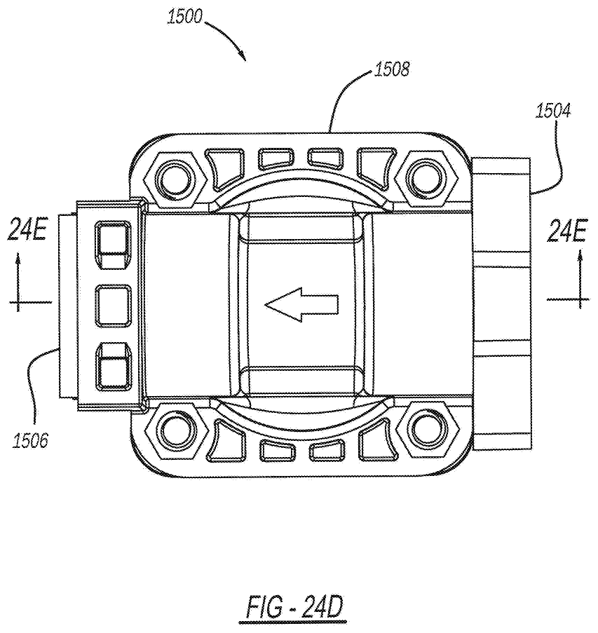

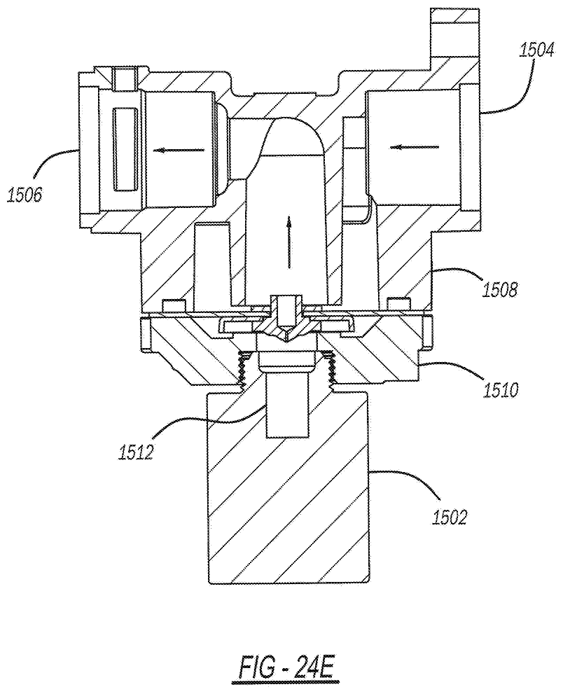

FIG. 24(a) to 24(d) show perspective views of a permeate valve according to the disclosure where the permeate valve may be used to control flow of permeate used to flush a system. Permeate valve may be mounted on cross-support as shown in FIG. 16 (a) or 16 (b). FIG. 24(e) shows a cross-section through a permeate valve. FIG. 24(d) has an arrow that indicates the location of the cross-section. Solenoid permeate valve assembly 1500 has solenoid 1502, permeate inlet 1504, permeate outlet 1506, upper valve body part 1508 and lower valve body part 1510. FIG. 24(e) further shows a valve pintle head 1512 and valve seal 1514. According to the disclosure, permeate, for example, from a tank flows to permeate valve inlet 1504. In examples where flushing is to be performed, solenoid 1502 may be deactivated. releasing valve seal 1514 and allowing permeate flow through the valve to permeate outlet 1506. Permeate may then flow to reverse osmosis cartridges for flushing.

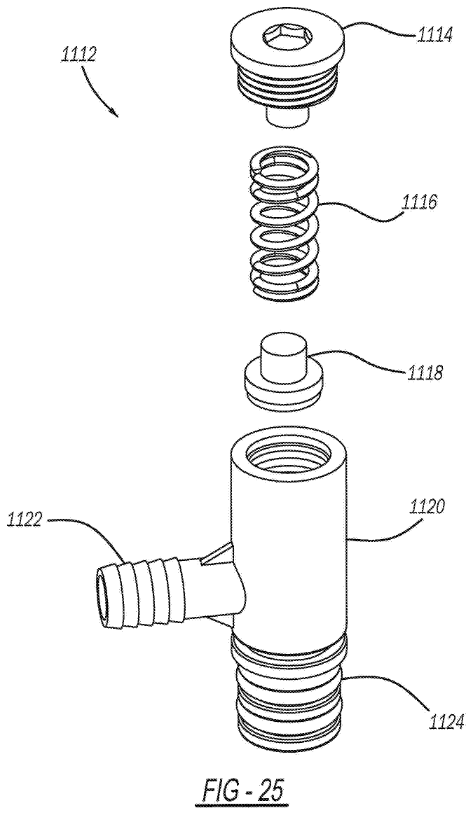

FIG. 25 shows pressure relief valve 1112 in an exploded view in FIG. 31. Pressure relief valve 1112 includes, housing 1120, cap 1114, spring 1116, and plug 1118. Inlet 1122 and 1124 outlet are shown. Pressure relief valve 1112 may be positioned at one or more sites in the system, such as, for example, the tank or the post-permeate filtration assembly.

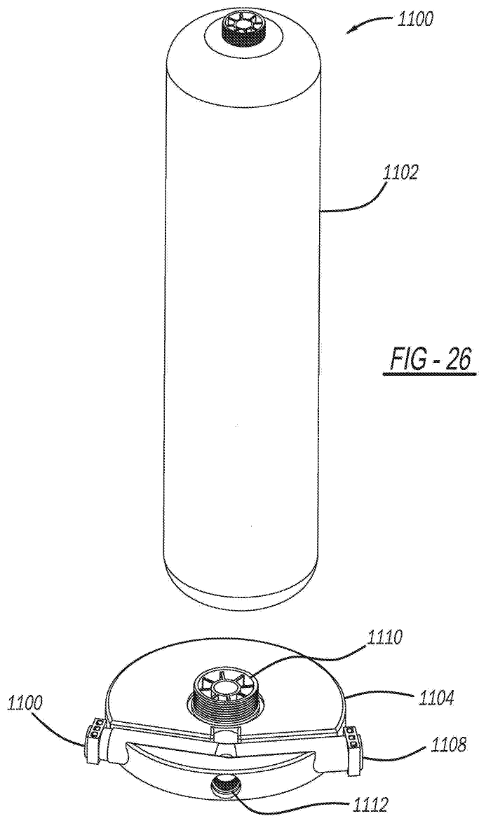

FIG. 26 shows one example of a tank assembly 1100 according to the disclosure. Tank 1102, tank end cap 1104, permeate inlet 1100, permeate outlet 1108, and tooling plug 1112. In this example, the tank may be formed from fiber-reinforced plastic.

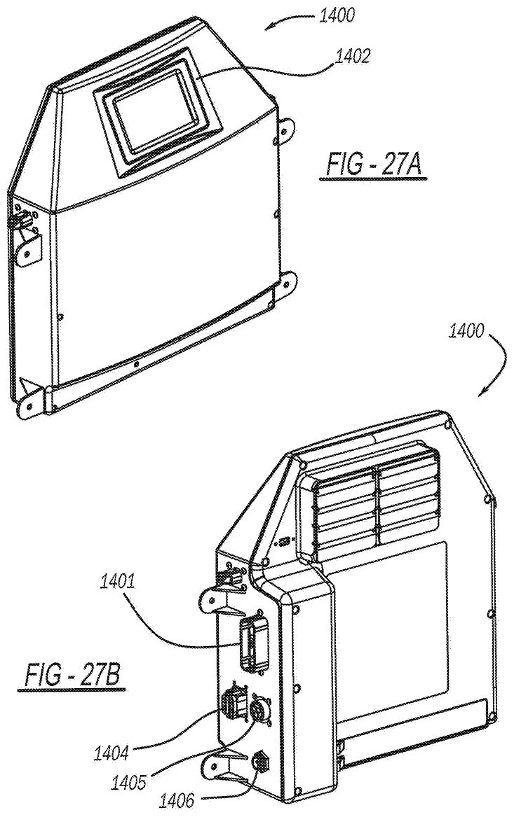

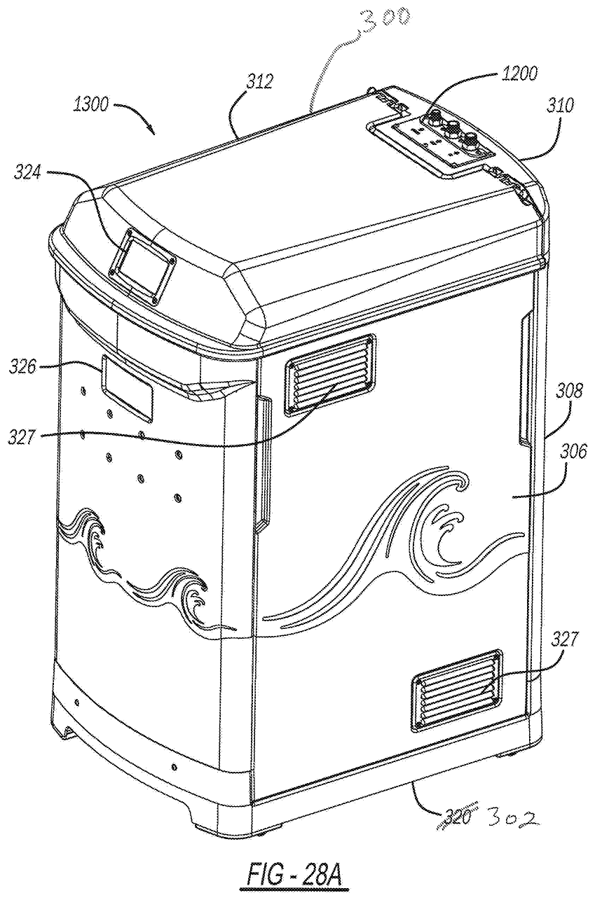

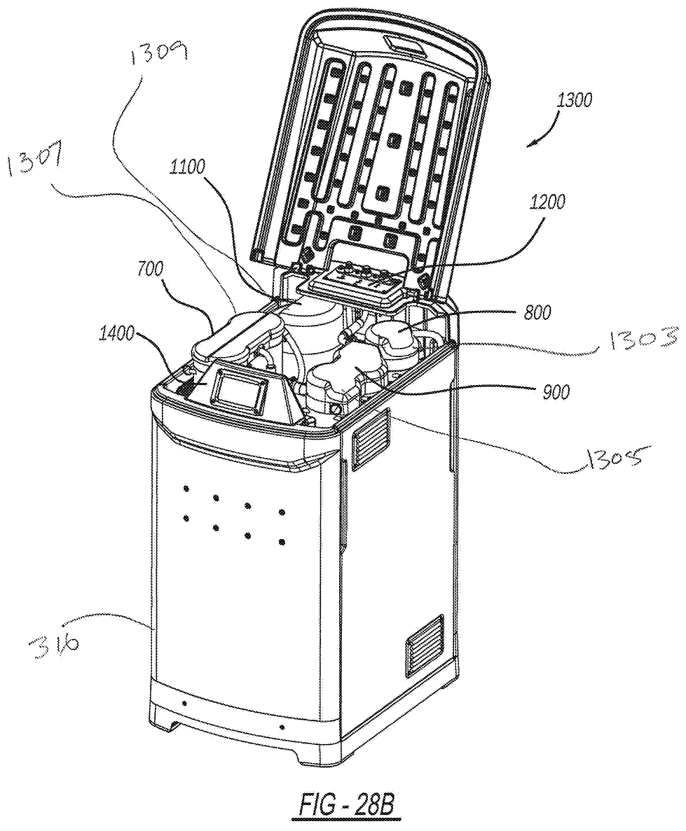

FIGS. 27(a) and (b) shows external perspective views of the front and back of an electronics assembly 1400 which includes screen 1402, and electrical connections 1401,1404,1405, and 1406.

FIGS. 28 to 30 show different interior views of a further example of a water treatment system according to the disclosure, showing the placement of different assemblies. These Figures show the mounting of assemblies onto an enclosure and the relative positioning of the system components.

FIG. 28(a) shows a perspective view of the exterior of an assembled water treatment system. FIGS. 28(b) to (f) show the interior of a water treatment system, with components of the enclosure or other assemblies removed to show the relative placement of components. In these figures, assemblies and other components are referred using previously used reference numbers. Water treatment system 1300 includes enclosure 300, pump assembly 400, recirculation and disposal manifolds 1700,1600, reverse osmosis cartridge assembly 700, post-permeate filtration assembly 800, filtration assembly 900, tank assembly 1100, outlet/inlet assembly 1200 and electronics assembly 1400. Components of the enclosure are shown, including unit base 302, right side panel 304, left side panel 306, back panel 308, front panel 316. Crossbridge 314 and inlet AC power pack 328 are also shown. As shown in the Figures, various assemblies may have caps (1303,1305,1307,1309) when placed within an enclosure.

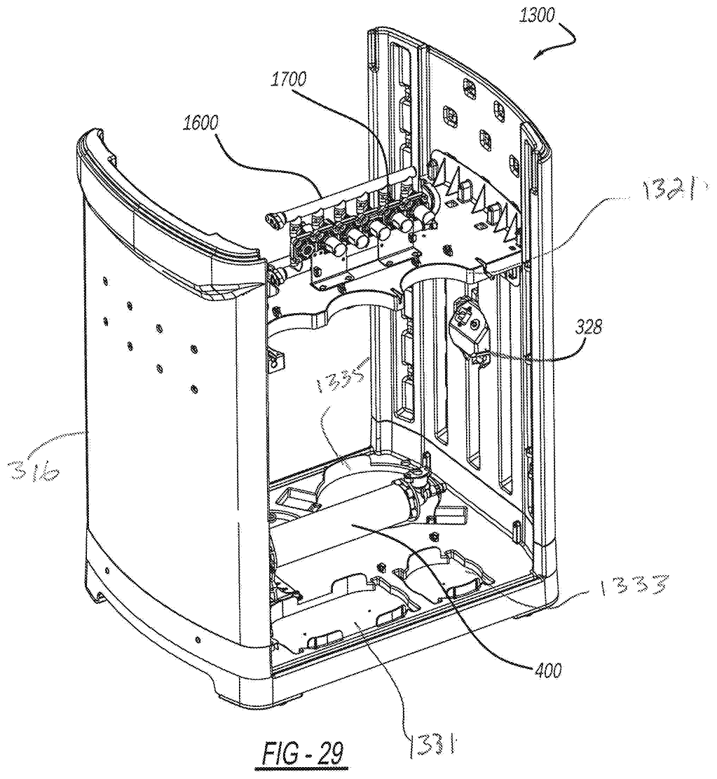

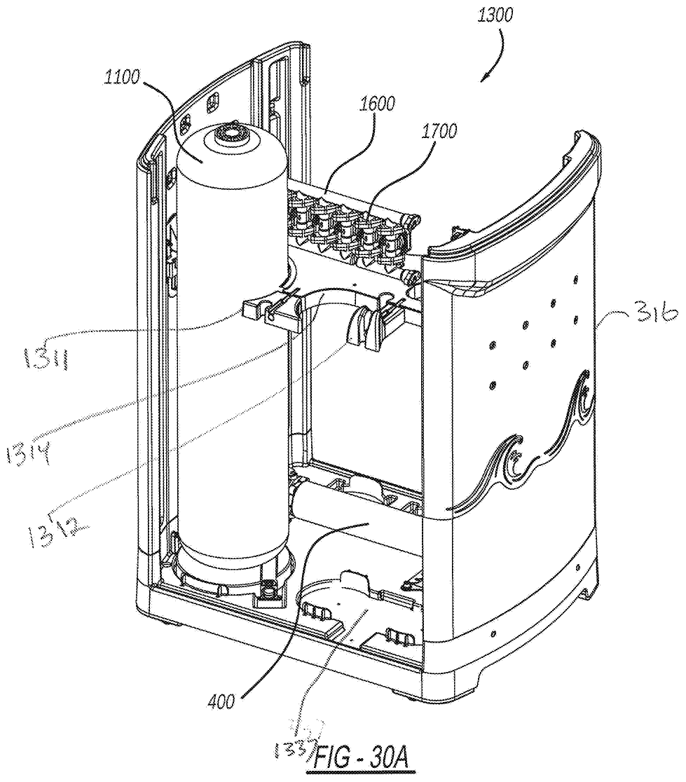

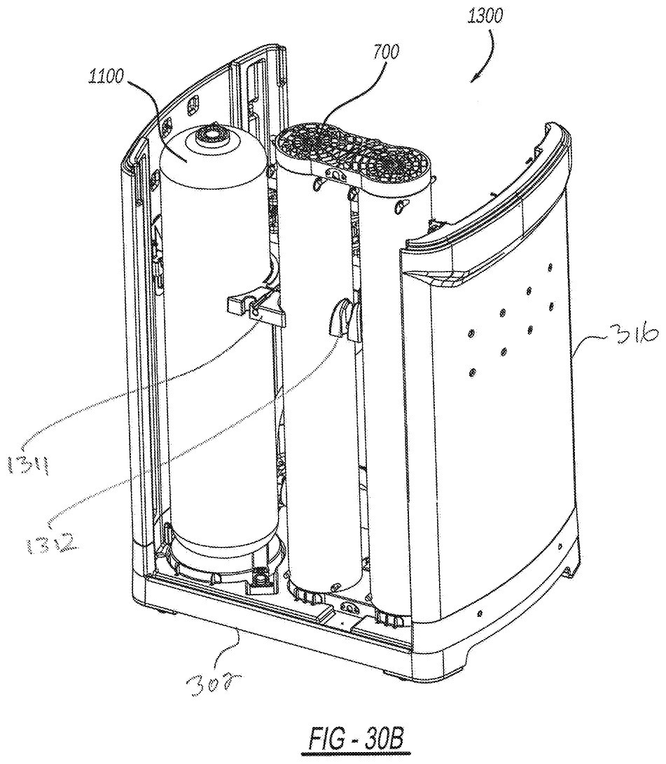

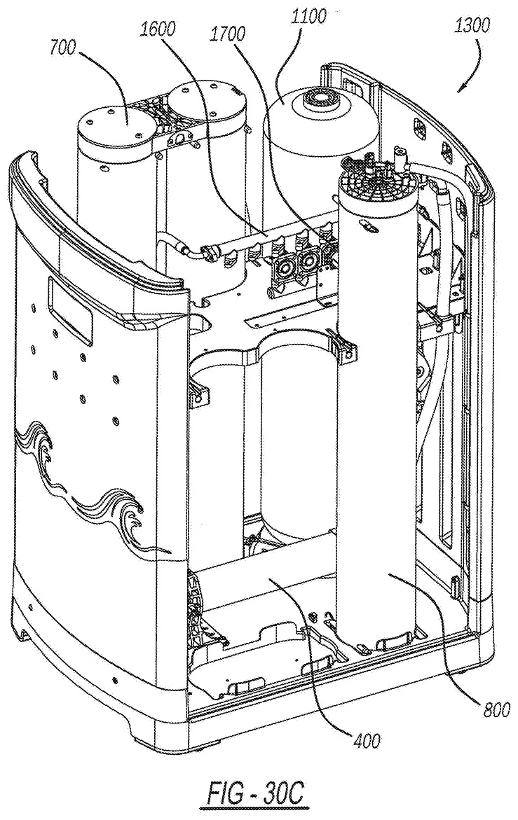

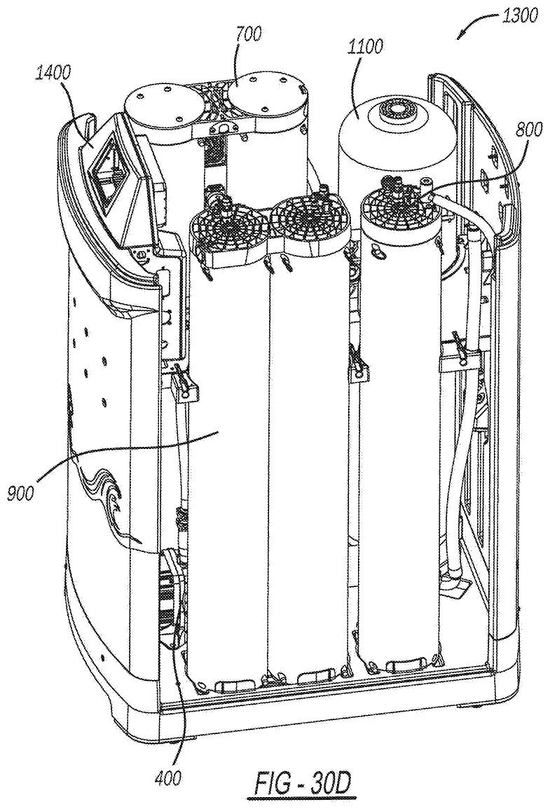

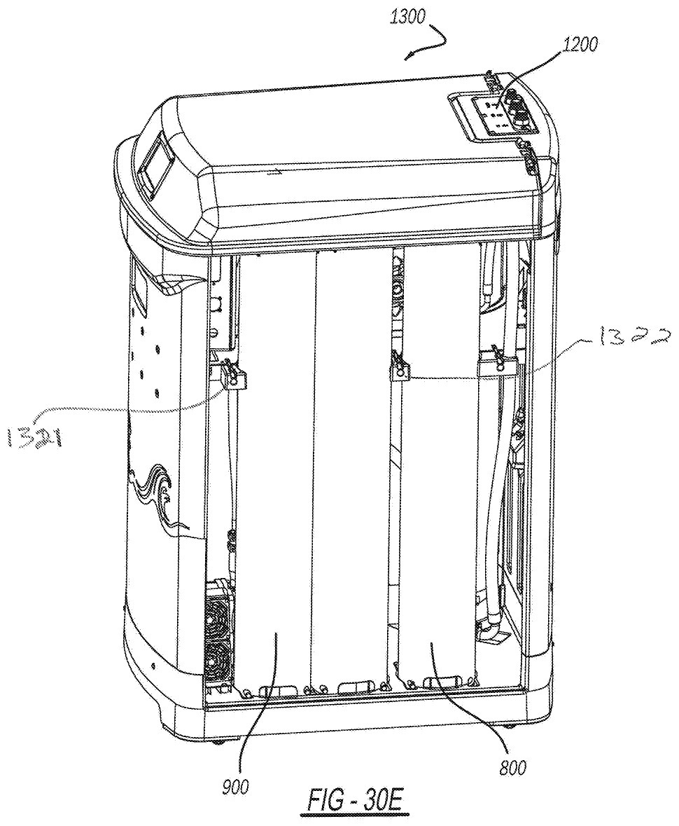

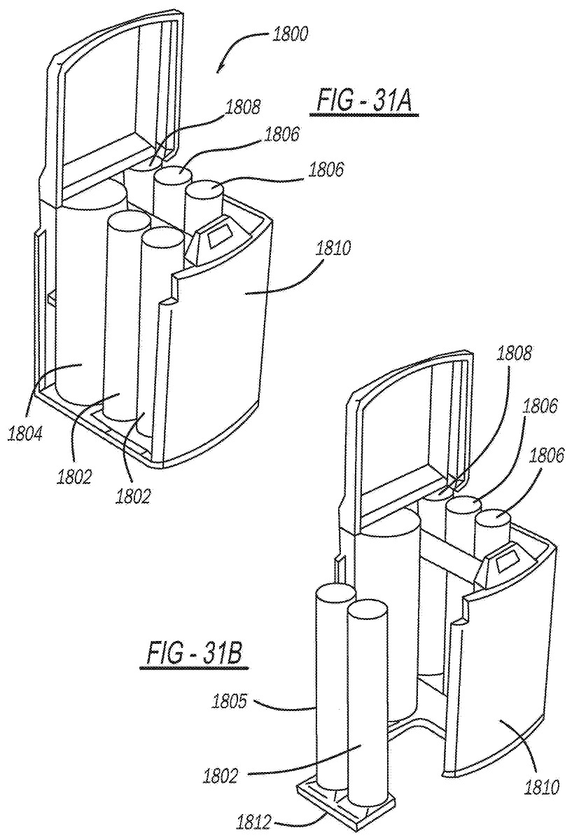

These caps may provide additional protection for the assemblies from the environment while the system is running. These caps may be easily removed for servicing. FIGS. 28 to 30 also illustrate how assemblies and other components may be fitted securely into the enclosure. For example, the enclosure includes depressions (1331,1333,1335,1337) into which components may be inserted, as shown, for example, in FIG. 29. As shown, for example, in FIGS. 30(a) and (b), the cross support 314 have receiving portions (e.g. 1315,1314) into which components may placed for support and where wedges 1311,1312 may be inserted to secure components. Wedges are also shown 1321, 1322 are also illustrated in FIG. 30(e).

FIG. 29 shows water treatment system with most assembled removed to show the interior of the enclosure. FIGS. 30 (a) to 30(e) show the placement of different assemblies in an example of a water treatment system of the disclosure.

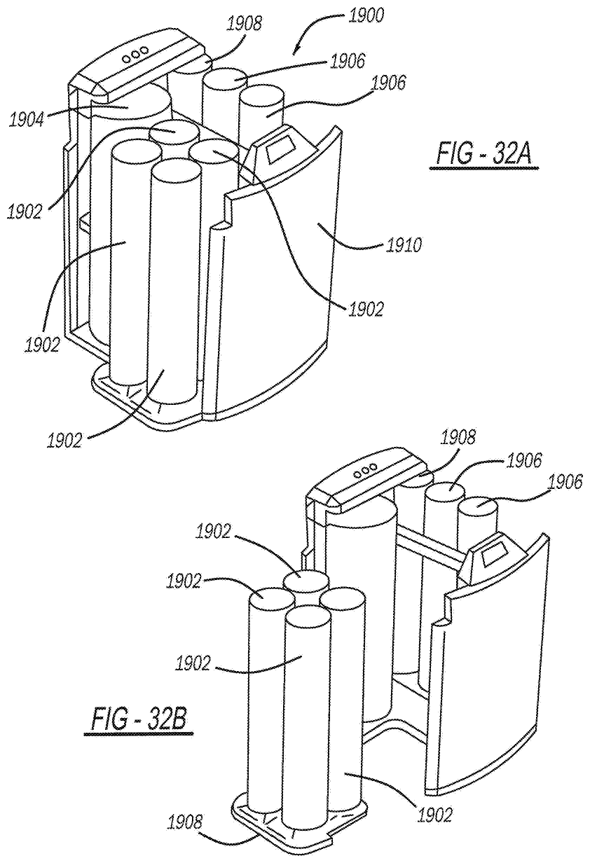

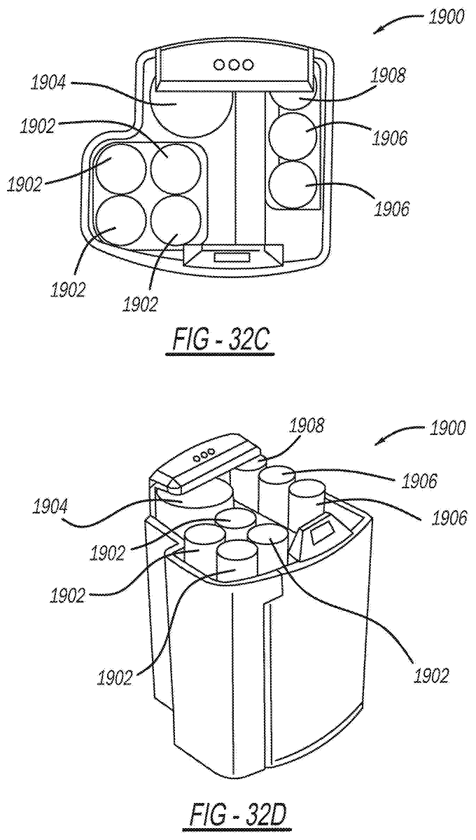

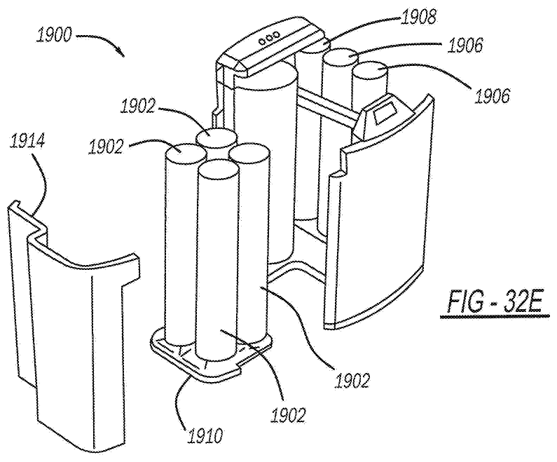

FIGS. 31 and 32 show further examples of water treatment systems according to the disclosure. These figures show schematics of the arrangements of assemblies in water treatment systems. FIGS. 31 (a) and (b) shows a water treatment system 1800, showing the placement of reverse osmosis cartridges 1802, a tank 1804, Filtration cartridges 1806, tank 1808 and enclosure 1810. FIG. 31(a) shows an assembled water treatment system with the right-side panel removed to show the interior and with the lid raised. FIG. 31(b) shows the same water treatment system with a reverse osmosis cartridge assembly 1812 reversibly detached from the enclosure. The reversible detachment of the reverse osmosis cartridge assembly 1812 allows the assembly to be replaced or repaired more easily. The assembly 1812 may be then reattached for use.

FIGS. 32 (a) to (e) shows a water treatment system 1900, showing the placement of reverse osmosis cartridges 1902, a tank 1904, filtration cartridges 1906, tank 1908 and enclosure 1910. In this example, there are four reverse osmosis cartridges 1902. FIG. 32(a) shows an assembled water treatment system with the right-side panel removed to show the interior and with the lid raised. FIG. 32(b) shows the same water treatment system with a reverse osmosis cartridge assembly 1912 reversibly detached from the enclosure. The reversible detachment of the reverse osmosis cartridge assembly 1912 allows the assembly to be replaced or repaired more easily. The assembly 1912 may be then reattached for use. FIG. 32(c) shows this example from above with the lid removed to view the interior. FIG. 32(d) shows the system with the right-side panel 1914 in place but with the lid removed to show the interior. FIG. 32(e) shows the reversible detachment of the right-side panel 1914 and the reverse osmosis cartridge assembly 1912, to facilitate installation and repair of the reverse osmosis cartridge assembly or other components of the assembly.

The forging description is meant to be exemplary only and many modifications and variations of the present disclosure are possible in light of the above teachings. It is, therefore, to be understood that within the scope of the disclosure, systems and methods may be practiced otherwise than as specifically described.

1. A water treatment system, comprising:
at least one reverse osmosis cartridge;
at least one filtration cartridge;
at least one pump; and
an enclosure.

2. The water treatment system of claim 1 wherein said water treatment system comprises at least two reverse osmosis cartridges.

3. The water treatment system of claim 1 wherein said at least two reverse osmosis cartridges are connected in parallel.

4. The water treatment system of claim 3 wherein said at least two reverse osmosis cartridges comprise a reverse osmosis cartridge assembly.

5. The water treatment system of claim 1 further comprising a post-permeate filter assembly.

6. The water treatment system of claim 1 wherein said post permeate filter assembly comprises at least two post-permeate filtration units.

7. The water treatment system of claim 1 wherein said water treatment system further comprises at least two filtration cartridges.

8. The water treatment system of claim 7 wherein each of said at least two filtration cartridges comprise at least two filtration units.

9. The water treatment system of claim 8 wherein said at least two filtration units comprise a filtration assembly.

10. The water treatment system of claim 1 wherein said water treatment system further comprises at least one valve assembly for recirculating concentrate.

11. The water treatment system of claim 10 wherein said at least one valve assembly comprises solenoid valves.

12. The water treatment system of claim 10 wherein said at least one valve assembly comprises step valves.

13. The water treatment system of claim 1 wherein said water treatment system further comprises a tank.

14. The water treatment system of claim 13 wherein said tank holds from about six gallons to about 24 gallons.

15. The water treatment system of claim 12 wherein said tank comprises fiber-reinforced plastic.

16. The water treatment system of claim 12 wherein said tank is bladderless.

17. The water treatment system of claim 1 wherein said water treatment system further comprises a permeate valve, wherein said permeate valve regulates the flow of permeate for flushing said water treatment system.

18. The water treatment system of claim 1 further comprising at least one pump assembly wherein said pump assembly comprises a mixing bowl.

19. The water treatment system of claim 18 wherein said at least pump assembly comprises at least one turbine.

20. The water treatment system of claim 18 wherein said pump assembly comprises at least three ports.
